(19) United States
(12) Patent Application Publication
(10) Pub. No.: US 2010/0200136 A1
(43) Pub. Date: Aug. 12, 2010

(54) Modular Tire with Variable Tread Surfaces

(76) Inventor: Brian H. Hamilton, Charlotte, NC (US)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 12/725,654

(22) Filed: Mar. 17, 2010

Related U.S. Application Data
(63) Continuation-in-part of application No. 12/206,696, filed on Sep. 8, 2008.
(60) Provisional application No. 61/160,809, filed on Mar. 17, 2009.

(51) Int. Cl. B60C 11/00; B29D 30/08

(52) U.S. Cl. 152/209.11; 156/128.1

(57) ABSTRACT

A new kind of tire utilizes a replaceable tread surface to enable variable tread characteristics determined by a removable riding surface. The tire body defines a slot that extends circumferentially around the tire and receives the removable riding surface. The removable riding surface is attached within the slot by attachment mechanisms. In other embodiments, the variable tread is accomplished via a removable sleeve that fits over the existing tire.

### CROSS REFERENCE TO RELATED APPLICATIONS

This application claims the benefit of priority of provisional patent application Ser. No. 61/160,809 for the magnetic trainer filed on Mar. 17, 2009. The prior application is incorporated by reference in its entirety herein.

This application further claims the benefit of priority as a continuation-in-part of co-pending patent application Ser. No. 12/206,696 for the magnetic trainer filed on Sep. 8, 2008. The co-pending prior application is incorporated by reference in its entirety herein.

### FIELD OF THE INVENTION

The invention relates to the field of tires, particularly bicycle tires, for which modified treads and riding surfaces are useful to control the amount of surface area and therefore friction between the tire and the road surface. The invention also relates to the ability to alter riding surfaces quickly and easily during a single riding experience.

### BACKGROUND OF THE INVENTION

The tire industry has not changed in any major way in the recent past. Consumers use tires for all kinds of vehicles, which, for purposes of the invention disclosed herein, include any devices used for transportation. The problem with conventional tires is that upon extended use, the tires become worn and must be replaced. Replacing tires is one of the most expensive purchases in maintaining a vehicle.

When replacing tires, either on a bicycle or other vehicle, the consumer must replace the entire tire even though only the portion that engages the road is worn. On most tires, the sides of the tire are completely functional long after the riding surface has lost all of its tread. There exists a need for consumers to be able to replace the riding surface of a tire without replacing the entire tire.

### BRIEF SUMMARY OF THE INVENTION

The invention is a new kind of tire that utilizes a replaceable tread surface. The tread surface can be replaced because the tire is worn or because the consumer would like to use different kinds of treads on the same tire. For example, some consumers use their vehicles on more than one kind of surface (i.e., paved roads, unpaved roads, gravel paths, and the like). In the bicycle industry, it is quite common for consumers to need different tread surfaces for mountain trails and for rides on traditional roads. As used herein, the term “mountain type tread” means a mountain tire as known in the art and having larger knobs for a tread surface. A road type tread is also well known and is typically smooth for faster rides on paved surfaces.

In one embodiment, the tire disclosed herein has variable tread characteristics determined by a removable riding surface. The tire body defines a slot that extends circumferentially around the tire and receives the removable riding surface. The removable riding surface is attached within the slot by attachment mechanisms described below.

In other embodiments, the variable tread is accomplished via a removable sleeve that fits over the existing tire.

### BRIEF DESCRIPTION OF THE DRAWINGS

FIG. 1 shows a tire with a replaceable sleeve over the outer surface.

FIG. 2 shows a cross section of the tire of FIG. 1.

FIG. 3 shows an outer sleeve attached to a tire by a bead attached to a rim holding the tire.

FIG. 4 shows a tire having a sleeve with a reinforced layer therein.

FIG. 5 shows a tire having a protective layer as described herein.

FIG. 6 shows a tire having a noise dampening layer as described herein.

FIG. 7 shows a slotted tire according to the invention herein.

FIG. 8 shows a slotted tire with a removable riding surface positioned therein.

FIG. 9 shows a slotted tire having a removable riding surface with a multifaceted riding surface therein.

FIG. 10 shows a slotted tire having a removable mountain bike tread attached within the slot via an attachment mechanism as described herein.

FIG. 11 shows a slotted tire having a removable road type bicycle tread attached within the slot via an attachment mechanism as described herein.

FIG. 12A shows a slotted tire having a removable road type riding surface positioned with the slot.

FIG. 12B shows a slotted tire having a removable mountain type riding surface positioned within the slot.

FIG. 13 shows a slotted tire having openings for attaching a removable riding surface therein.

FIG. 14 shows the slotted tire of FIG. 13 with attachment mechanisms holding a removable riding surface through the openings therein.

FIG. 15 shows a side view of the slotted tire of FIG. 13.

FIG. 16 shows a side view of the slotted tire of FIG. 14 at the point where the ends of the removable riding surface meet.

FIG. 17 shows a slotted tire according to FIG. 13 but with parallel rows of openings for attaching the removable riding surface.

FIG. 18 shows a slotted tire having a tube shaped insert therein.

FIG. 19 is an exploded view of the tire of FIG. 18.

FIG. 20 is a top view of a tire having removable attachments creating a riding surface of reduced surface area.

FIG. 21 is a second design for the attachments of FIG. 20.

FIG. 22A shows a tire having an outward protrusion emanating from a groove in a grooved tire and providing a rail for sliding a mated strip thereon.

FIG. 22B is a cross section of the tire of FIG. 22A with a mated strip attached to the rail.

FIG. 23 shows the openings in the tire of FIG. 22 for receiving an insertable riding surface.

FIG. 24 shows an insert creating a reduced friction riding surface and fitting into the openings of FIG. 23.

FIG. 25 shows an insertable riding surface having winged portions that engage the underside of the tire.

FIG. 26 shows another shape of openings for receiving insertable riding surfaces into a tire as described herein.

FIG. 27 shows an insert for fitting into the openings shown in FIG. 26.

FIG. 28 shows a cross section of the tire of FIG. 26 with inserts as shown in FIG. 27 in place therein.

FIG. 29 shows the insert of FIG. 27 with a pliable base as described below.

FIG. 30 shows an insert having a pellet that creates a reduced friction riding surface.

FIG. 31 shows the tire of FIG. 30 with the riding surface deformed as shown by the pellets therein.

FIG. 32 illustrates a new tire that defines a cavity along the outer aspect of the tire between the tire undersurface and a separating membrane that is positioned adjacent to the inner tube.

FIG. 33 is a cross sectional view of the embodiment of FIG. 32 with the inner tube fully inflated.

FIG. 34A shows another configuration for the implant used in the cavity of FIG. 32.

FIG. 34B shows yet another configuration for the implant used in the cavity of FIG. 32.

FIG. 35A shows a slotted tire as described herein with surface openings for receiving an insert therein.

FIG. 35B shows a slotted tire according to FIG. 35A with the insert in place.

FIG. 35C shows a close up view of FIG. 35B.

FIG. 36A shows a slotted tire adapted to receive an implant having a circular base and an outer riding surface with variable configurations.

FIG. 36B shows an implant according to FIG. 36A wherein the outer riding surface screws on to a threaded neck portion of the implant.

FIG. 36C shows a riding surface connected to the implant of FIG. 36A.

FIG. 37 shows a smaller inner implant within an outer implant that encircles the inner portion.

FIG. 38 shows an insert with winged tabs that fit within a slot in the tire and connect to the undersurface of the tire and defines a cavity within its body containing an implant that is held in place by a membrane having a collar through which the neck of the implant extends.

FIG. 39 shows the grooved tire fitted with an inflatable strip for altering the shape of the riding surface that engages the road.

FIG. 40 shows the inflatable strip of FIG. 30 with an opening for inflating the same.

FIG. 41 shows the access available for inflating the inflatable strip of FIG. 39.

FIG. 42 shows the valves available for inflating the inflatable strip of FIG. 39.

FIG. 43 shows a solid circumferential tube for forming an adjustable riding surface that engages the road.

FIG. 44A shows a tire utilizing a bladder for moving a riding surface from a depressed position to an outwardly extended position.

FIG. 44B shows the bladder of FIG. 44A in the extended position.

FIGS. 45A and 45B shows a tire having a variable riding surface via a bead therein.

FIGS. 46A and 46B shows a tire having a variable riding surface via an inflatable conduit therein.

### DETAILED DESCRIPTION

### Attachables

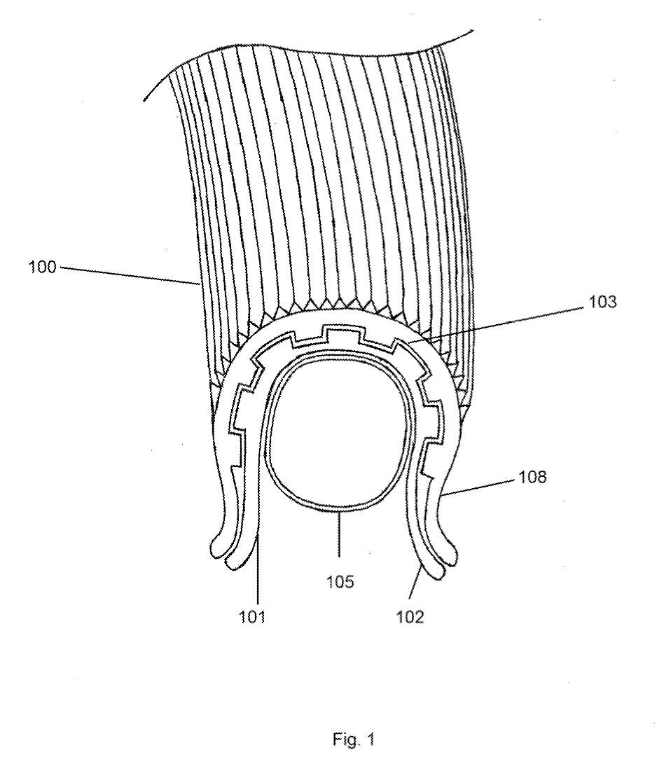

FIG. 1 shows a perspective view of a bicycle tire sleeve (100) for covering an existing bicycle tire (101) to change the tread that a rider uses for engaging the road. The existing tire (101) may be a mountain bike or a road bike tire (101). The sleeve (100) modifies the tread by providing a new surface that can be attached and removed easily by deflating the inner tube (105) and tucking the beads (102, 104) of the tire (101) and sleeve (100) into the rim (106) and reinflating the inner tube (105). In FIG. 1, the sleeve (100) changes a mountain bike tire (101) into a smoother tire surface for faster road travel (i.e., a conversion from a mountain tire (101) to a road tire (101)). The sleeve (100) includes an inter-digitating inner surface (103) for fitting more securely within the tread of the existing mountain bike tire (101). Once the beads (102, 104) of both the tire (101) and sleeve (100) are tucked into the bicycle wheel rim (106), the inner tube (105) is re-inflated to secure both the tire (101) and the sleeve (100) in place. The sleeve bead (104) is outside the bicycle tire bead (102) within the rim.

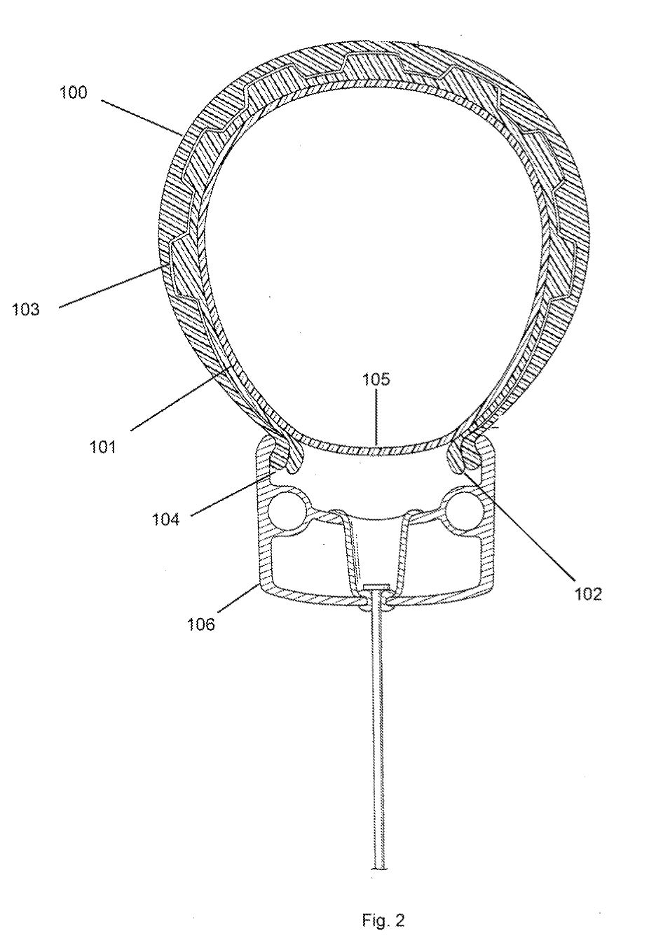

FIG. 2 shows a cross section of the embodiment of FIG. 1 and shows that the inner, interdigitating surface (103) of the sleeve (100) matches the groove pattern of the existing tire (101) for additional security from slippage. The sleeve (100) includes a sleeve bead (104) for fitting within the rim (106) of the bicycle wheel adjacent to the bead (102) of the existing tire (101). The rim (106) holds both the existing tire (101) and the sleeve (100) in place when the inner tube (105) is re-inflated.

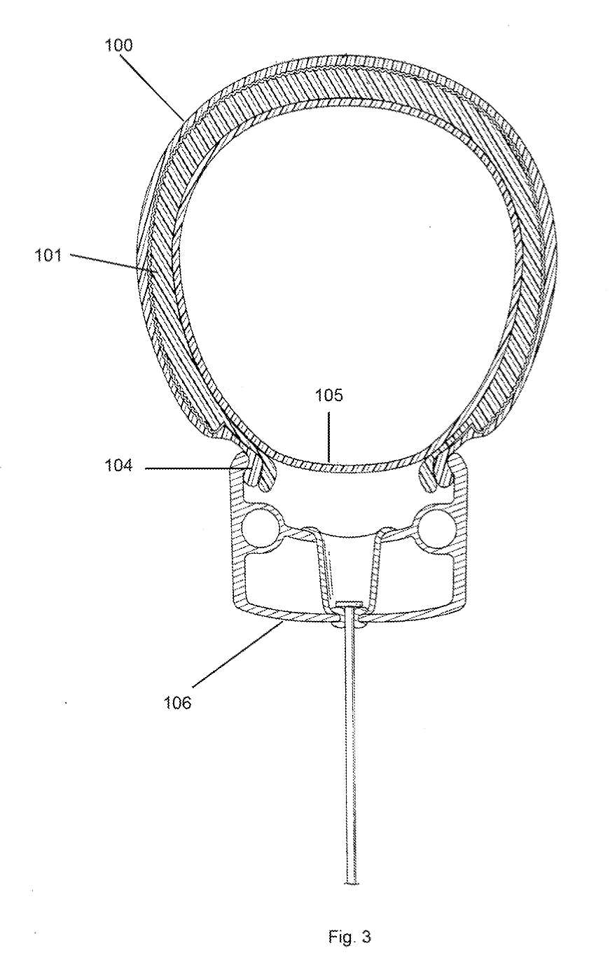

FIG. 3 illustrates a similar concept as shown in FIG. 1 in that a sleeve (100) covers an existing tire (101) and fits securely within the bicycle wheel rim (106) by a bead (104) on the sleeve. In FIG. 3, however, the sleeve (100) covers an existing road bike tire (101) with a protective sleeve (100) of similar tread for training purposes. Road bike tires (101) require frequent replacement due to the fact that road bike tires (101) are made of less durable, thinner material but allow significantly faster travel on the road. In this regard, the combination of a road bike tire (101) and a protective sleeve (100) prevents the rider from wearing down the existing road bike tire (101). By incorporating the protective sleeve (100) of this invention, the rider protects the existing road bike tire (101) and uses the sleeve (100) for training purposes. The sleeve is easily removed for race conditions and replaced by deflating and re-inflating the existing road bike tire (101) as noted above.

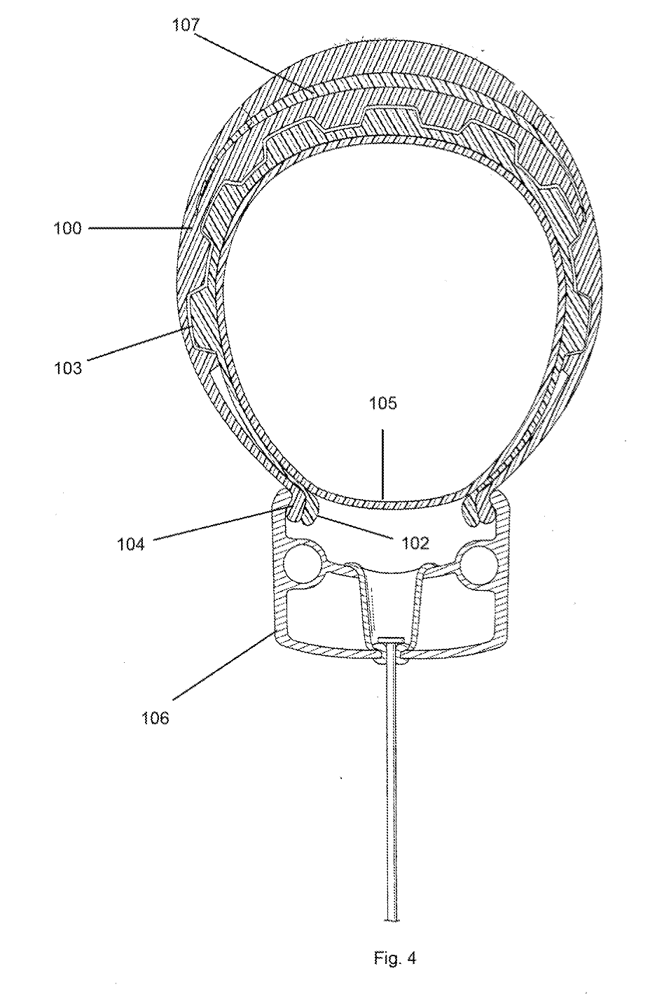

FIG. 4 shows yet another improvement to the embodiment of FIG. 1 by incorporating a puncture resistant protective layer (107) within the body of the sleeve (100). In summary, FIG. 4 illustrates a bicycle tire sleeve (100) that includes a bead (104) for attaching within the bicycle wheel rim (106) adjacent the bead (102) of an existing bicycle tire (101). In this illustration, the existing bicycle tire (101) is a mountain bike tire. The rider deflates the existing inner tube (105) and tucks the sleeve (100) into the rim (106) before re-inflating the inner tube (105) for a secure fit within the rim (106). Similar to FIGS. 1 and 2, the sleeve (100) of this embodiment includes an interdigitating inner surface (103) that engages the grooves on an existing mountain bike tire (101). The puncture resistant protective layer (107) is positioned within the body of the sleeve (100) between the interdigitating inner surface (103) and the outer surface of the sleeve (100) contacting the road.

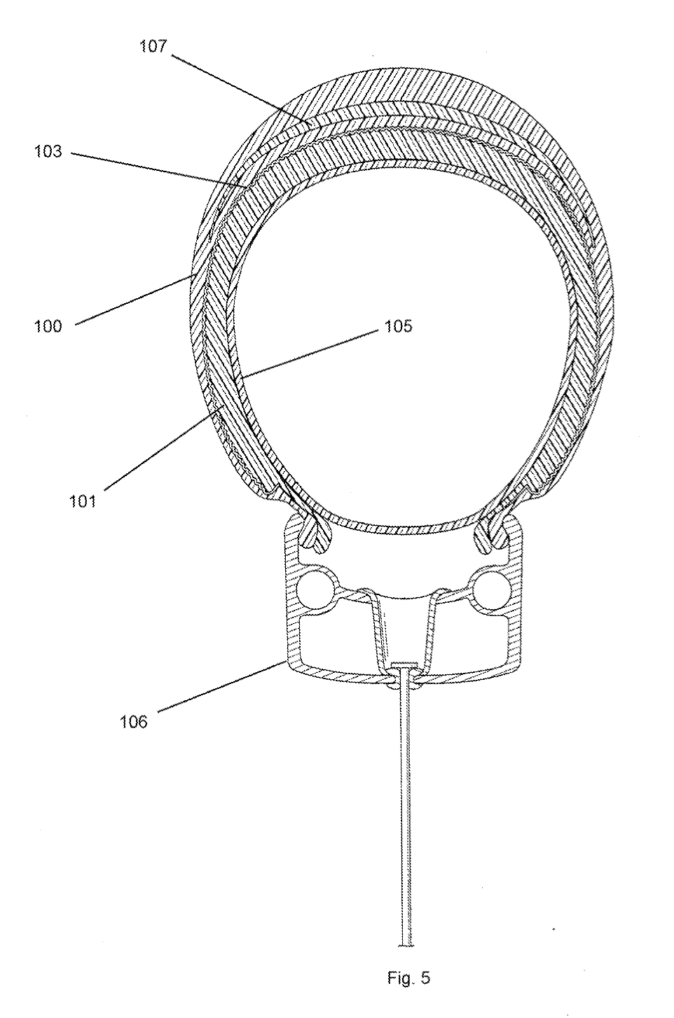

FIG. 5 shows the protective layer (107) of FIG. 4 applied to a road tire (101) embodiment similar to that described above for FIG. 3.

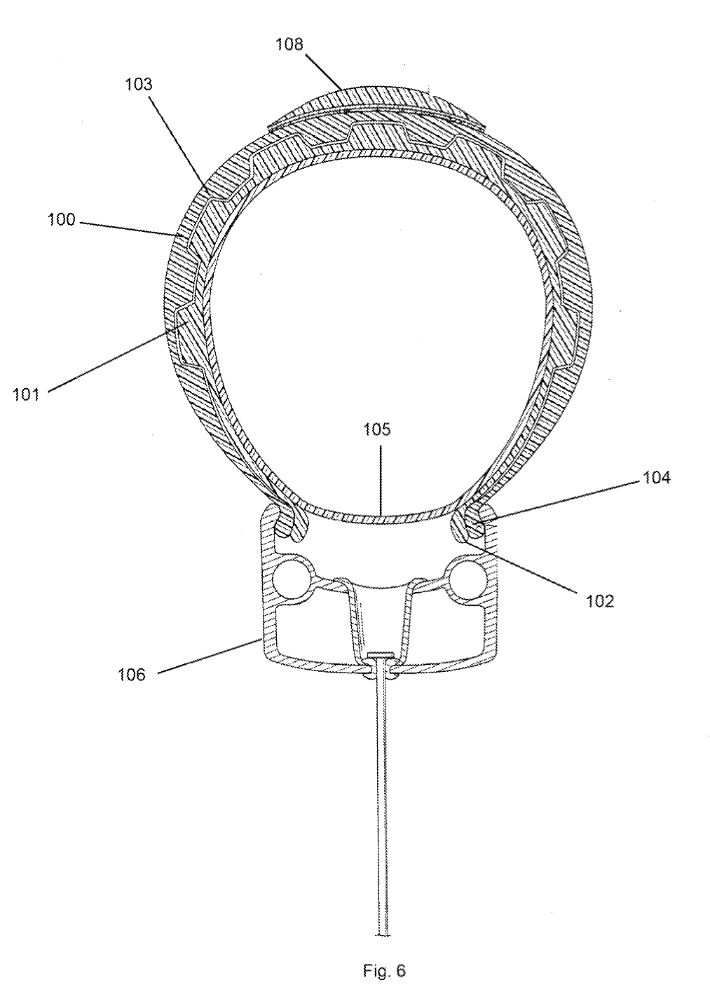

FIG. 6 shows an improvement to the invention of FIG. 2 and incorporates a noise dampening outer layer (108) attached to the sleeve. This noise dampening outer layer (108) may be attached by any number of attachment mechanisms, including but not limited to the hook and loop design. This embodiment is useful for workouts using a bicycle trainer. When a rider places a bicycle on a trainer, often the back tire engages a metal cylinder which can wear down the tread of an existing bicycle tire (101). The inventions of FIGS. 1-5 are useful for protecting the existing tire (101) during exercises using a bicycle trainer. The noise dampening layer (108) shown in FIG. 6 significantly reduces the noise level produced by the back tire engaging the trainer, especially for mountain bike tires.

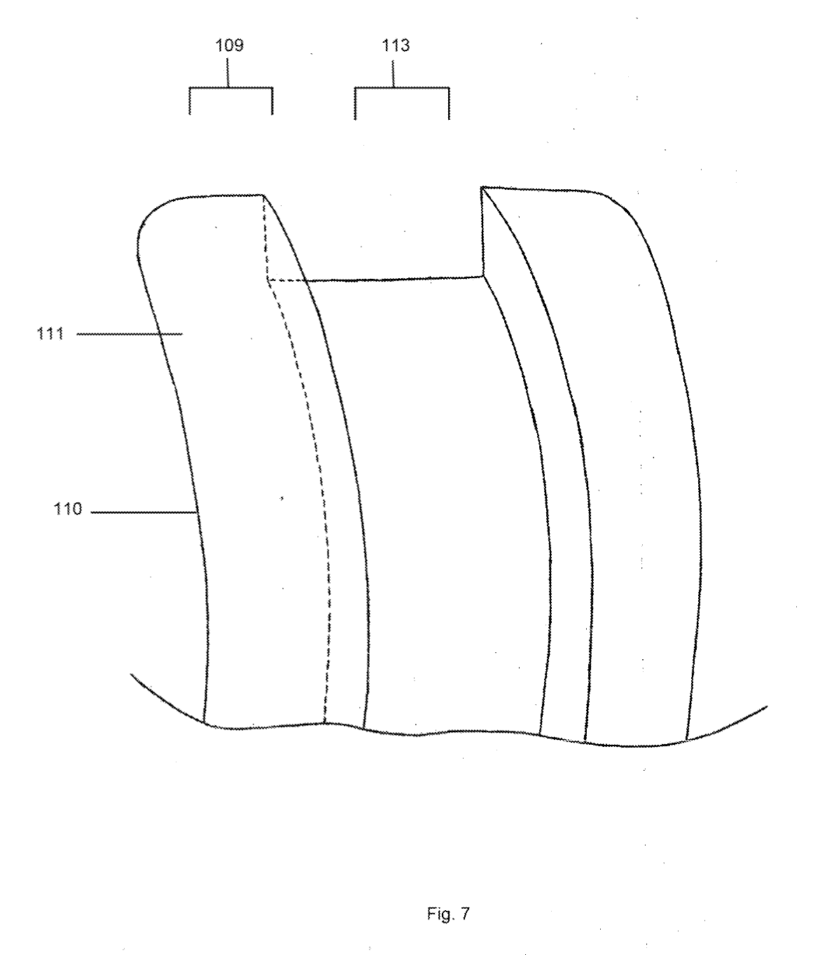

FIG. 7 shows a new tire (109) for use in accordance with this invention. See also, U.S. patent application Ser. No. 12/206,696 for the magnetic trainer filed on Sep. 9, 2008. In the prior art, the distance across a tire body, from one side of the rim to the other, includes (i) corresponding sidewalls (110) of the tire and (ii) tread (111) surface. A portion of the tread surface (111) engages the road on which a cyclist travels. As used herein, the term road includes any sidewalk, track, mountain trail or other surface on which a cyclist travels via bicycle. The tread (111) surface includes a riding surface (112) that engages the road at any given time, depending on the angle of the bicycle tire (109). In this sense, the riding surface (112) may change from one portion of the tread surface (111) to another portion of the tread surface as the cyclist turns corners or repositions his body in relation to the bicycle. The tire (109) body of FIG. 7 defines a groove (113) about the tire's entire circumference. The groove is located within the center of the tire body, equidistant from each sidewall (110).

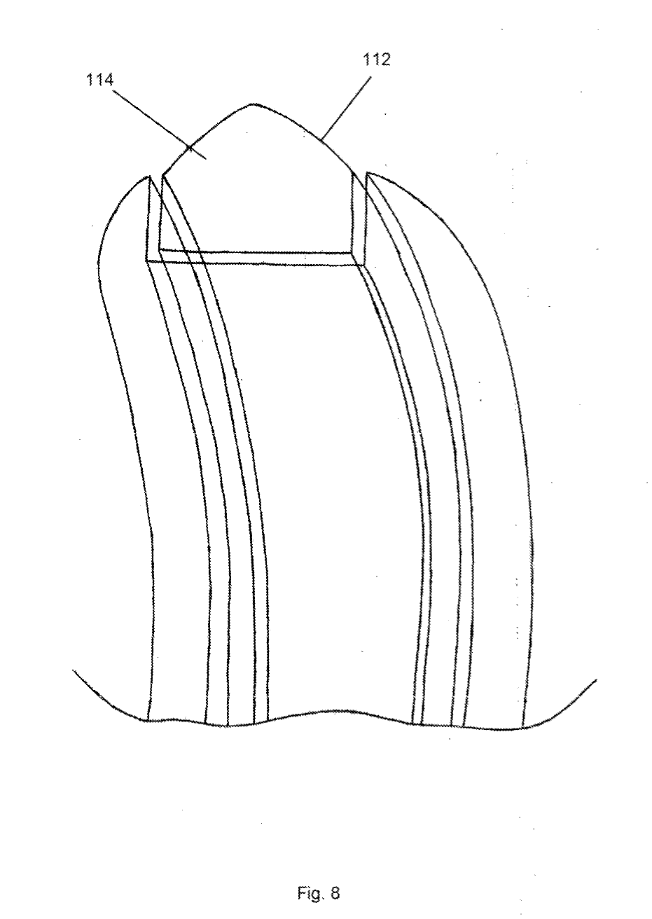

FIG. 8 shows a strip (114) inserted within the groove (113) defined by the tire (109) of FIG. 7. The removable strip (114) allows the cyclist to adjust the riding surface (112) on which the tire predominantly engages the road. In certain embodiments, the strip (114) of FIG. 8 may include mountain or road tire features, depending on road conditions. In a preferred embodiment, different strips (114) provide different riding surfaces (112), which may have specialized contours, treads, widths, and a means to alter the contours (e.g., inflatable strips discussed below). In this way, the strip (114) increases the functionality of a single grooved tire (109). In other words, the cyclist may attach a mountain tire strip (114A), a road tire strip (114B), or a particularly narrow riding surface (114C) for racing. Although not shown in FIG. 8, the strip may be attached by attachment mechanisms (117) including clips, Velcro, temporary glue, screws, push-through buttons, and the like.

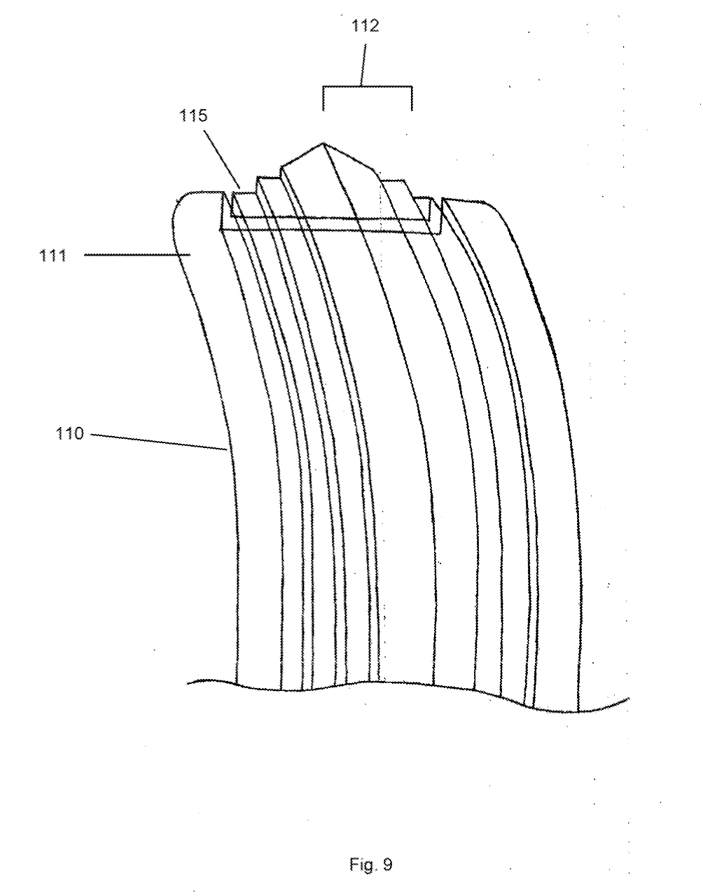

FIG. 9 shows the strip (114) of FIG. 8 with an optional design in which the strip (114) has a graduated height (115) from either edge to the center, giving a pyramidal shape on which the bicycle engages the road. The pyramid structure provides a narrow edge for faster travel due to diminished surface area. In addition, the pyramidal shape may decrease the weight of the strip (114) within the grooved tire (109).

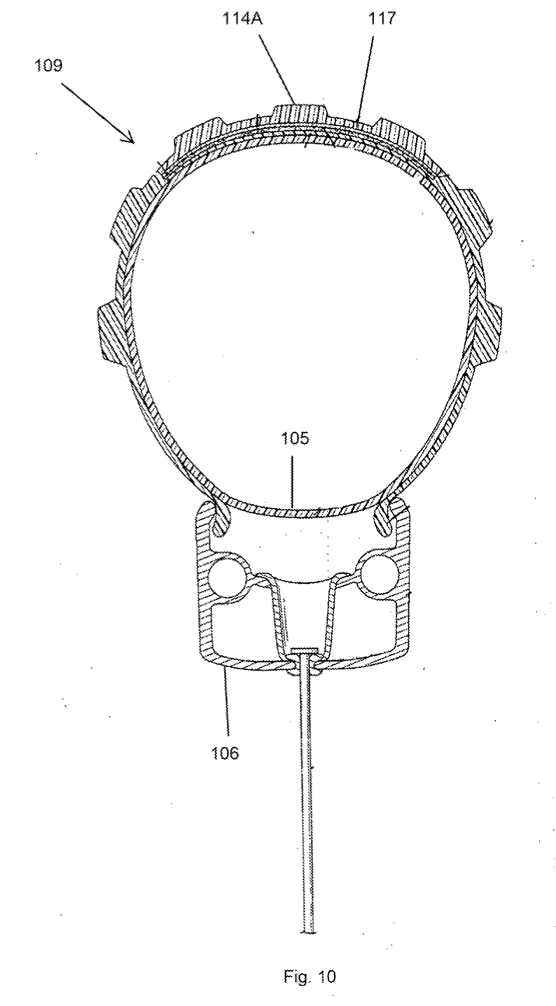

FIG. 10 shows a cross-sectional view of a grooved tire (109) as shown in FIG. 7 having a replaceable strip (114) attached within the groove (113). The strip (114A) of FIG. 10 includes mountain bike tread (114A) fitting within the groove (113) of the mountain bike tire (109). In this regard, when the tread (114A) on the strip (114) wears down, only the strip (114A) must be replaced. The strip (114A) may be attached by known attachment means (117) as described earlier. The goal of this embodiment is for the bicycle rider to maintain a grooved tire (109) on the bicycle with only the strip (114A,B,C) being replaced as necessary.

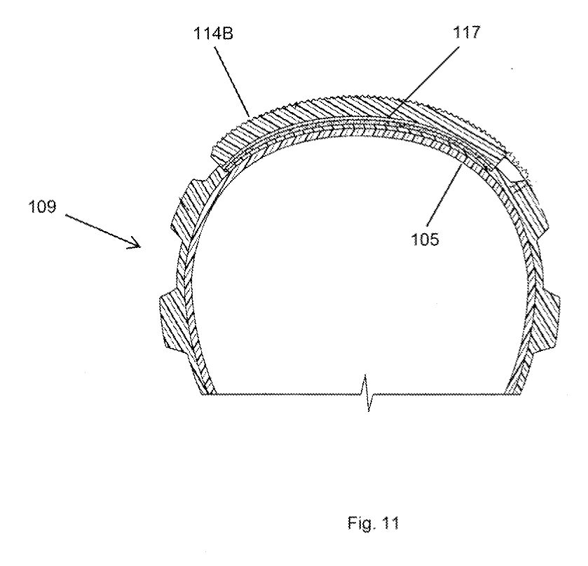

FIG. 11 shows a cross sectional view of a grooved mountain bike tire (109) having a conversion strip (114B) attached within the groove (113). The conversion strip (114B) changes the existing mountain bike tire to a road bike tire by providing a smoother tread for engaging the road. In certain forms, the conversion strip (114B) diminishes surface area, thus allowing faster travel on the road. In addition, the conversion strip (114B) allows flexibility in using a mountain bike on a road or vice versa. The conversion strip (114B) also provides the rider with the option of using the same originally installed bicycle tire (e.g., a grooved tire (109)) on different kinds of roads in a single work out. For example, the rider may use the road type tread (114B) to reach a mountain destination, and then change the strip (114B) to a mountain type of tread (114A) for temporary use on mountain trails. Afterwards, when the rider is finished with the mountain trail riding, a road type of conversion strip (114B) provides optimal conditions for returning to the original location. The embodiment of FIG. 11 also allows for refining the choice of strips (114), depending upon the exact conditions of the trail or road that the rider encounters. For example, a rider may choose different strips comprising different kinds of treads (114A, B) depending on the condition of a road or trail (e.g., muddy, wet, rocky, icy, dry, dusty, or steep). In other words, a conversion strip (114) incorporating a mountain type of tread (114A) may include numerous variations of the mountain tread (114A) to provide a greater selection of treads (114A, 114B) for different operating conditions. The same variety of treads (114A, 114B) is useful for road type conversion strips (114B) as well.

The conversion strip described herein also encompasses embodiments that incorporate side extensions connected to the strip. The side extensions are useful for tucking into the rim of a wheel and inflating an associated tire or inner tube such that the side extensions are fixed against the rim. This embodiment connects the strip to the tire body in a manner similar to the above described sleeves. The materials for the strip and the side extensions may be different, depending upon the application. For example, the strip may be formed of a vulcanized rubber or other synthetic material, and the side extensions may incorporate numerous textiles, plastics, magnetic materials, or ferromagnetic metals.

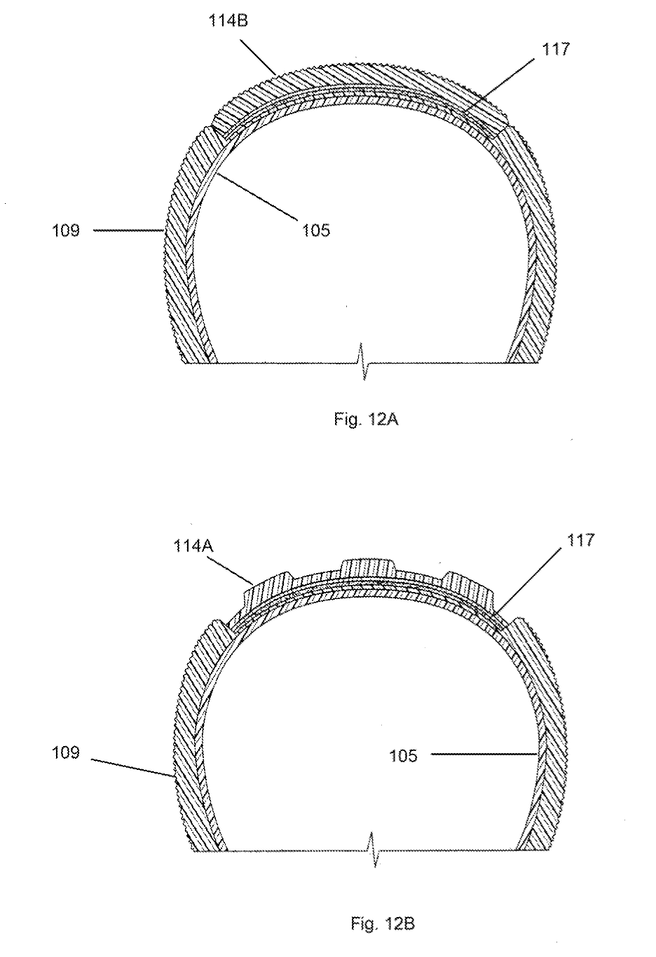

FIGS. 12A and 12B illustrate the conversion strip (114B) of FIG. 11 used with a grooved tire (109) originally intended for use with a road type tread (114B). FIG. 12A converts the road bike tire to a more specifically desirable road tread (114B). In this sense, FIG. 12A allows the rider to refine the selection of road bike tread (114B) while simultaneously providing a convenient mechanism for replacing worn treads (114) without replacing the originally installed grooved tire (109). Also, a rider using this embodiment has the option of customizing a road tire tread (114B) for various riding conditions. FIG. 12B converts a road bike tread (114B) to a mountain bike tread (114A). Both conversion strips are easily attached and detached without changing the originally installed grooved tire (109).

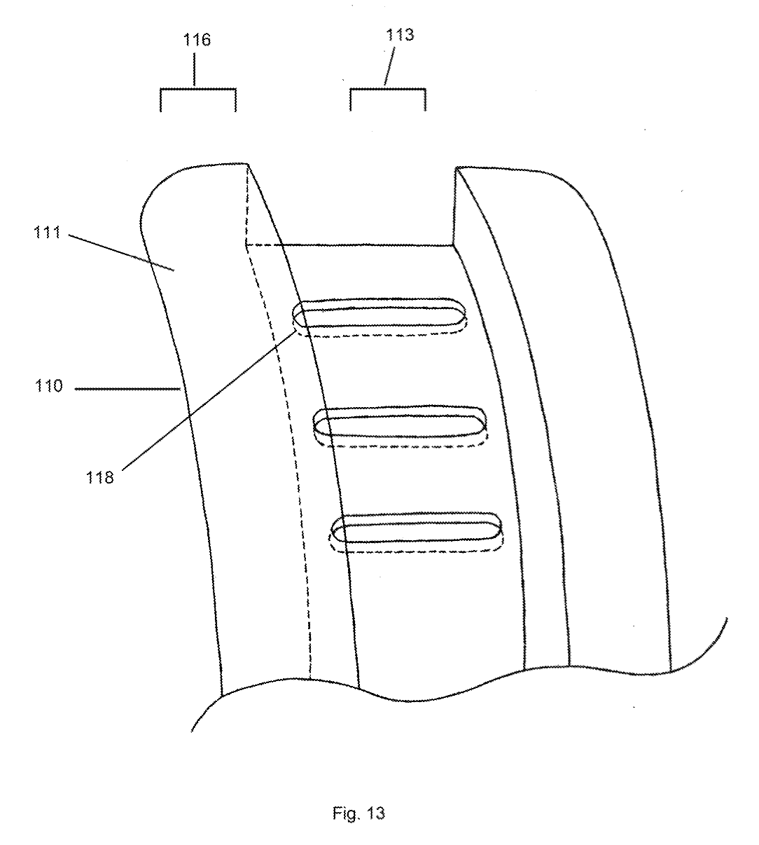

FIGS. 13-17 show perspective and cross sectional views of a new tire (116) to be used along with a replaceable strip (114) that fits within the groove (113) in the tire body (116), allowing for varying widths and treads (114) in contact with the road. The tire body (116) defines the width and depth of the groove (113) in which an attachment mechanism (117) fits within the groove (113) to secure the strip (114) thereon. Within the groove (113), the tire body (116) of FIG. 13 further defines slots (118) in which one type of attachment mechanism (117) slides through the slot and terminates within the tire along the underside (119) of the tire body (116).

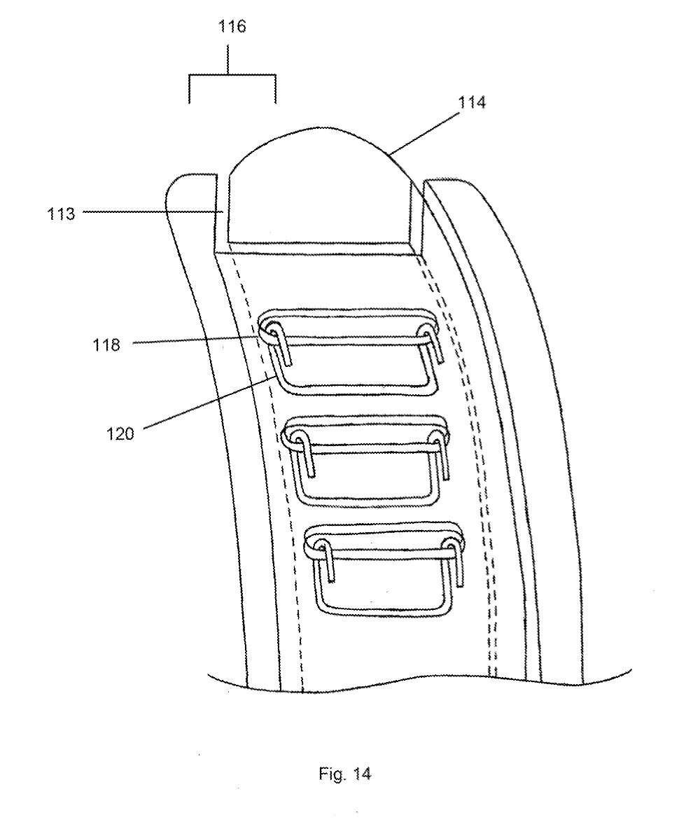

FIG. 14 is a perspective view of a section of the grooved tire (116) of FIG. 13 with a strip (114) attached therein. The strip (114) is attached via clips (120) that fit within the slots (118) of the groove (113) in the tire body. Each strip (114) provides a unique riding surface or tread (114A, B), depending on road conditions that a cyclist plans to encounter. The number and configuration of clips (120) used to attach the strip (114) to the grooved tire (116) may vary, depending on the tire circumference, the width of the strip (114), and the use of any other attachment mechanisms (117) used in conjunction with the clip (120) (e.g., Velcro or glue). As shown in FIG. 14, the attachment mechanism (117) may be a clip (120). In one embodiment, the clip (120) is attached, either permanently or temporarily, to the strip (114) and attaches the strip (114) to the tire body (116). A portion of the clip (120) fits within a slot (118) and is secured to the interior, or undersurface (119), of the tire body. The security of the clip (120) is enhanced by inflating the inner tube (105) within the tire and pressing the inner tube (105) against a portion of the clip (120).

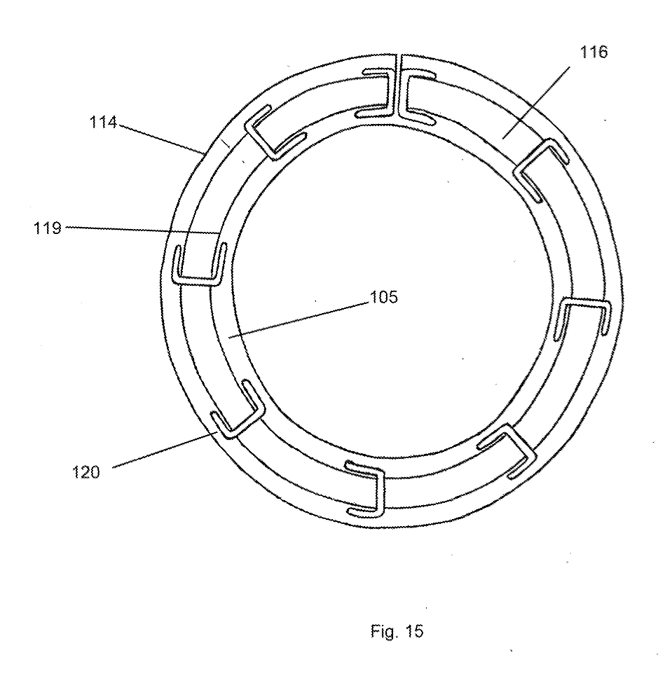

FIG. 15 shows a side view of the strip (114) to be attached to a grooved tire (116) as shown in FIG. 13. In FIG. 15, the clip (120) is integrally attached to a bottom portion of the strip (114), which will engage the tire body (116). The bottom portion of the clip (120) is available for sliding within the slot (118) defined within a groove in the tire body (116). In actual use, the bottom portion of the clip (120) is preferably flush with the undersurface (119) of the tire body (116). The clips (120) are designed to engage the inner tube (105) without puncturing the inner tube (105) (i.e., smoothed edges). FIG. 15 shows that the final clip (120) used to secure the strip (114) to the tire body (116) may be oriented opposite the first clip (120). The final clip (120) may fit within the same slot (118) as the first clip (120) for an even higher degree of security and for minimizing any gap between ends of the strip (114). The two ends may also have a separate attachment mechanism (117) connecting the two ends to each other (e.g., hook and loop tabs). By connecting the ends of the strip (114), the invention provides for a smooth and continuous riding surface (112).

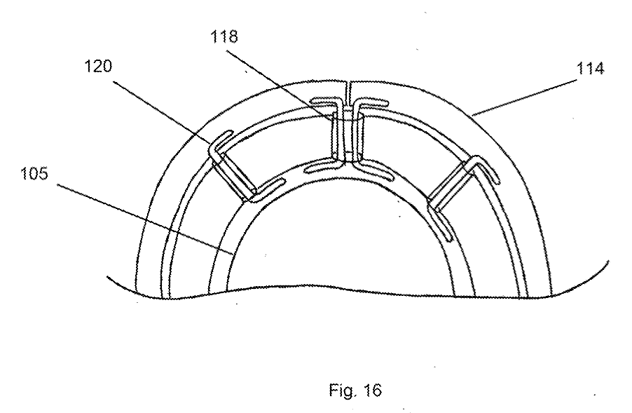

FIG. 16 shows a magnified view of the oppositely oriented first and last clip (120) holding the strip of FIG. 15 in place.

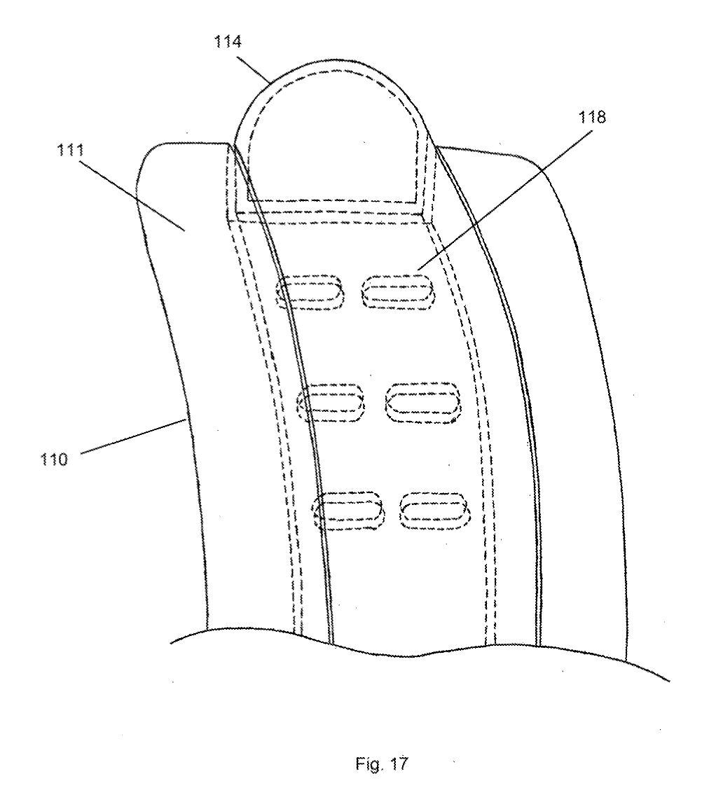

FIG. 17 shows that the slotted tire (116) of FIG. 13 may include parallel rows of two slots (118) each for engaging the attachment mechanism (117) of an associated strip (114).

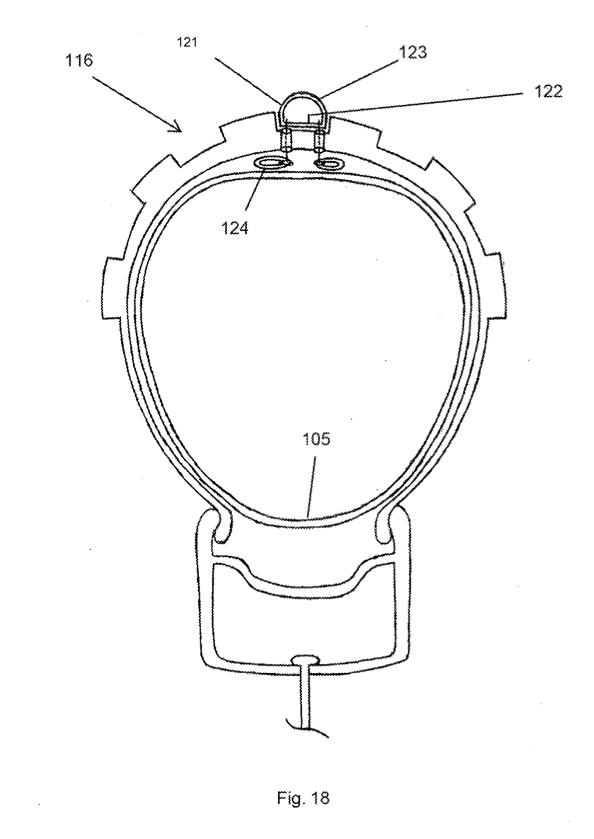

FIG. 18 shows yet another mechanism that is removably attachable to a grooved tire (116) such as that shown in FIG. 13. One option is to make the slots (118) of the grooved tire (116) narrower so that any attachment mechanism (117) inserted therein is held in place without any potential protrusion of the inner tube (105) through the slot (118). In the embodiment of FIG. 18, a tube shaped insert (121) fits within the groove (113) of the existing tire (116). The tube shaped insert (121) is flattened on the side (122) that engages the slot (118) of the tire and rounded on the side (123) that engages the road surface. As shown in FIG. 18, one possible attachment mechanism (117) includes rings (124) that fit within respective narrowed slots (118) in the grooved tire (116) and are held in place by inflation of the inner tube (105). The inflated inner tube (105) presses the rings against the undersurface (119) of the grooved tire. The rings (124) may be attached to the tube shaped insert (121) by known means including strings, fibers, and the like. In this embodiment, the slots (118) are sufficiently narrow to prevent the rings (124) from slipping outside the grooved tire (116).

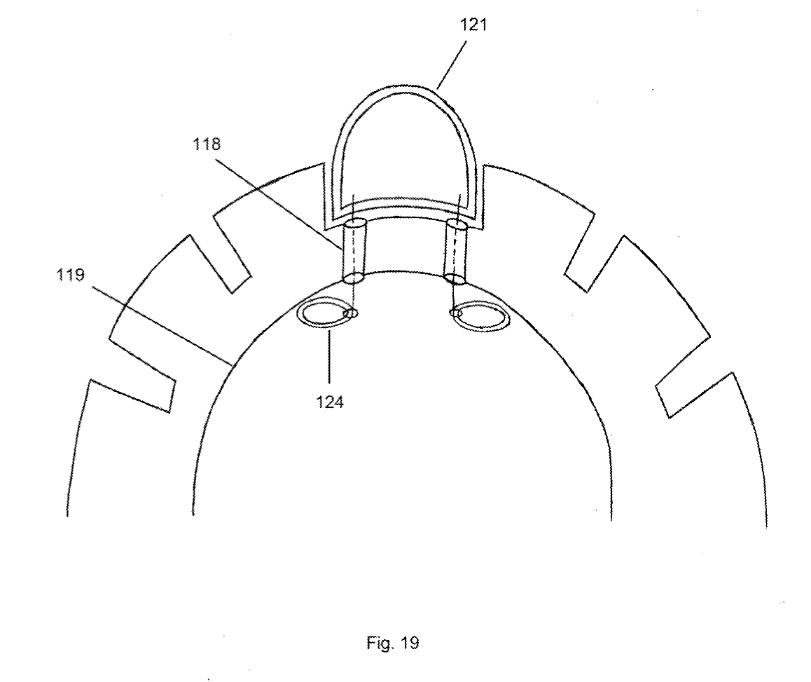

FIG. 19 shows a close-up view of the tube shaped insert (121) and its attachment mechanism (117). In FIG. 19 the narrowed slots (118) are shown as cylindrical openings in the grooved tire (116). An inner tube (not shown) would be inflated to a sufficient pressure to push the rings (124) against the undersurface (119) of the grooved tire (116).

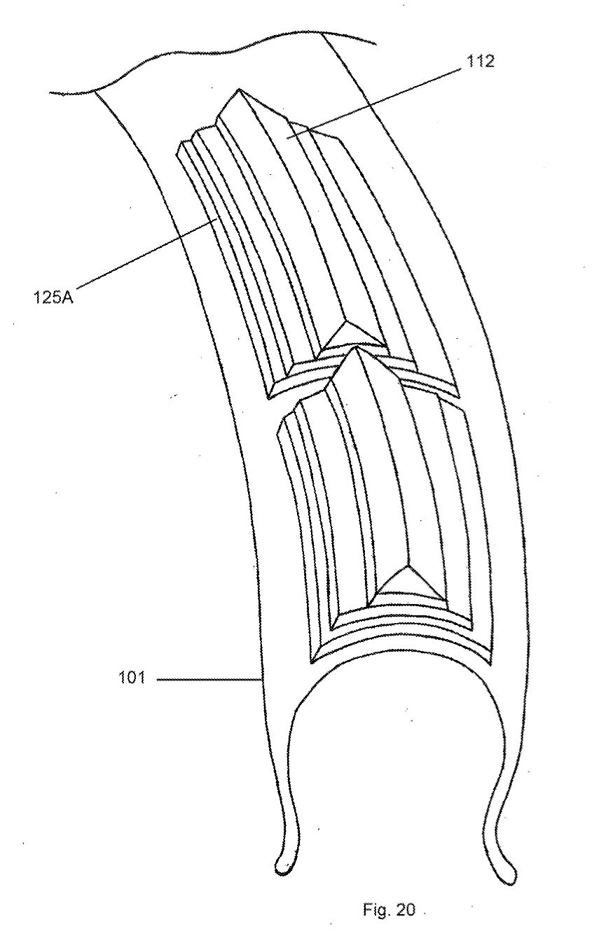

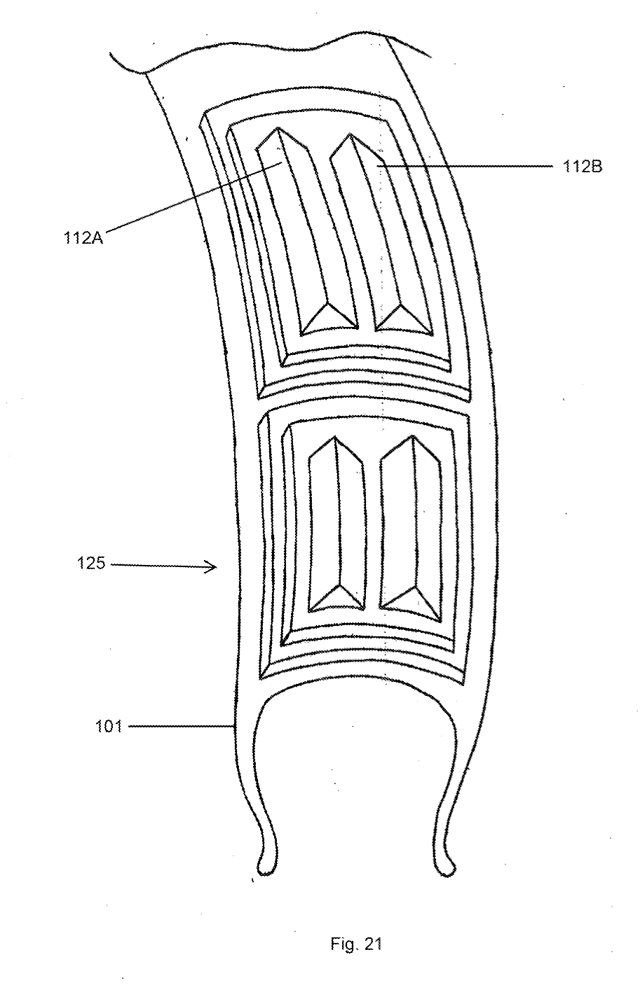

FIGS. 20 and 21 show another embodiment of a mechanism for changing the riding surface (112) of an existing bicycle tire (101). In FIG. 20, a series of patches (125) may be installed on an existing tire (101) having any tread surface (111), including a completely treadless, or smooth, tire. In a preferred embodiment, the patches are particularly useful on a specially manufactured smooth tire with an appropriate surface for attachment. The patches (125) provide a thinner riding surface (112) for faster bicycle travel. In FIG. 20, the patch (125) is a pyramidal shaped attachment (126) having a thin riding surface (112) for engaging the road. In FIG. 21, the patches (125) provide dual riding surfaces (112A, B) on respective pyramidal surfaces for increased stability. Known attachment means (117), including but not limited to hook and loop fasteners, temporary glues, or even clips or snaps, may be used to secure the patches (125) to the tire surface (111). In a preferred embodiment, the tire (101) may be manufactured with guiding lines (not shown) or other marks to ensure even placement of the series of patches (125).

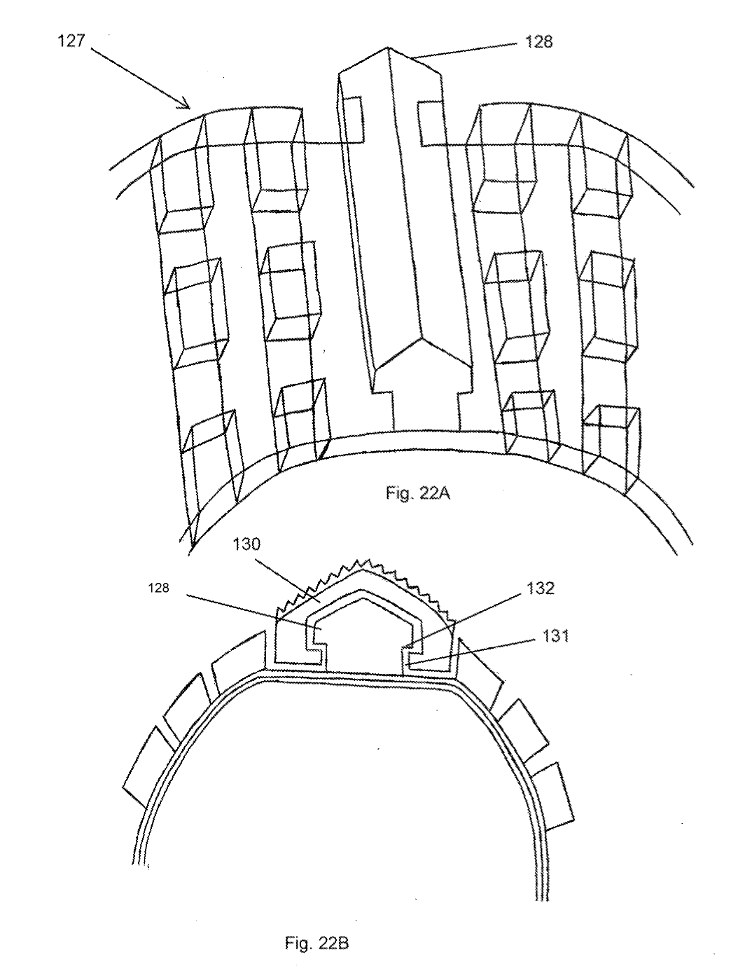

FIGS. 22A and 22B illustrate a new kind of tire based on the grooved tire (109) of FIG. 7 but having an additional element for receiving yet another tread attachment (114). In this embodiment, a protrusion (128) extends outwardly from the center of the groove (113) in the grooved tire (109) and provides a rail (129) for sliding a mated strip (130) about the tire circumference. FIG. 22B shows a cross sectional view of the strip (130) installed and fitted about the protrusion (128). The strip (130) defines a guiding cavity (131) along its underside which engages the protrusion (128) via lips (132) along the edge of the cavity (131). The lips (132) are along the underside of the protrusion (128) for security. The strip (130) may be either continuous or segmented, may have any desirable shape, and may provide either road type treads (114B) or mountain bike treads (114A), depending upon the use at hand.

### Insertables

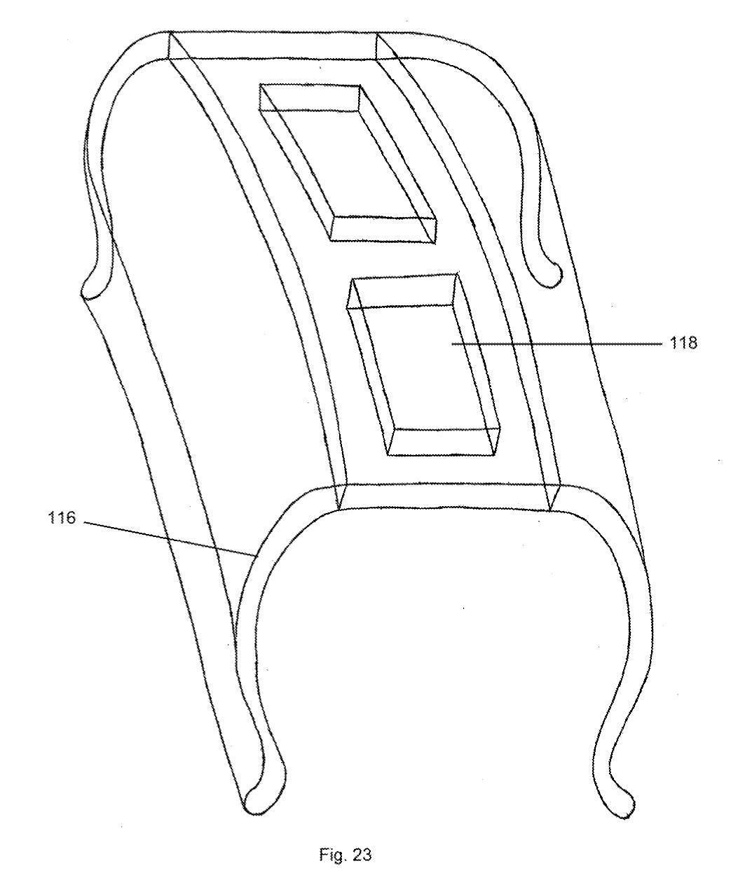

FIGS. 23-29 illustrate tires for attaching strips (214) as described above with new securing mechanisms (217). In one sense, the tires for use with “insertables” described herein may be any standard bicycle tire having appropriate openings for the securing mechanisms (217). In a different aspect, the grooved tire (116) of FIG. 13 would also provide similar functionality. The securing mechanisms (217) include inserts (220A) that engage the tire (116) through slots (118) that open through the entire thickness of tire body (116). The inserts (220) have sufficient flexibility for compressing and fitting through the slot (118) of the tire body (116) before re-expansion along the undersurface (119) of the tire body (116). In addition, the inserts (220A), particularly the base portion (221) that fits within the tire body (116), may provide protection from puncture of the inner tube (105). This protective feature may be enhanced by incorporating specialized materials or structures within the insert (220A) (e.g., Kevlar layers). These inserts may be continuous around the circumference of the tire body (116) to form one strip used as the riding surface (112), or the inserts (220A) may be individual segments that collectively form the riding surface (112).

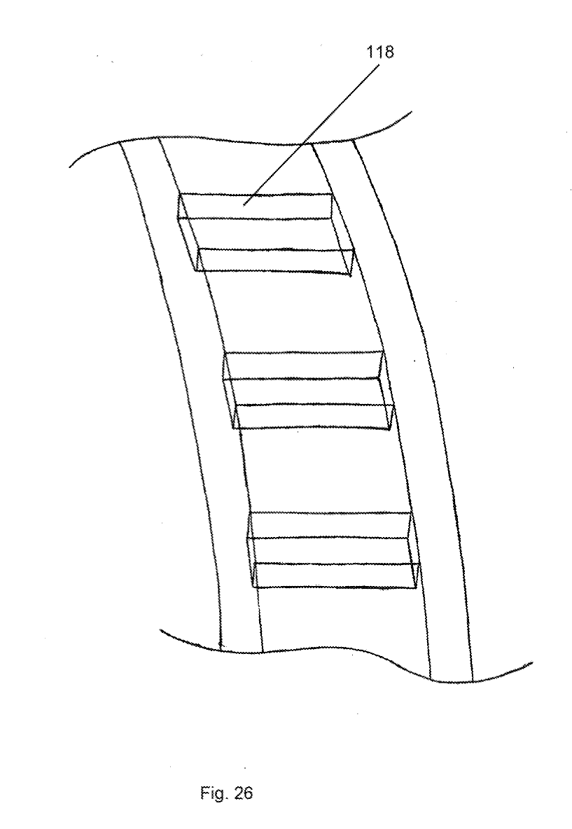

FIG. 23 shows one example of the slots (118) oriented along the long axis of the tire body (116). By comparison, FIG. 26 shows the slots (118) oriented perpendicular to the long axis of the tire body (116).

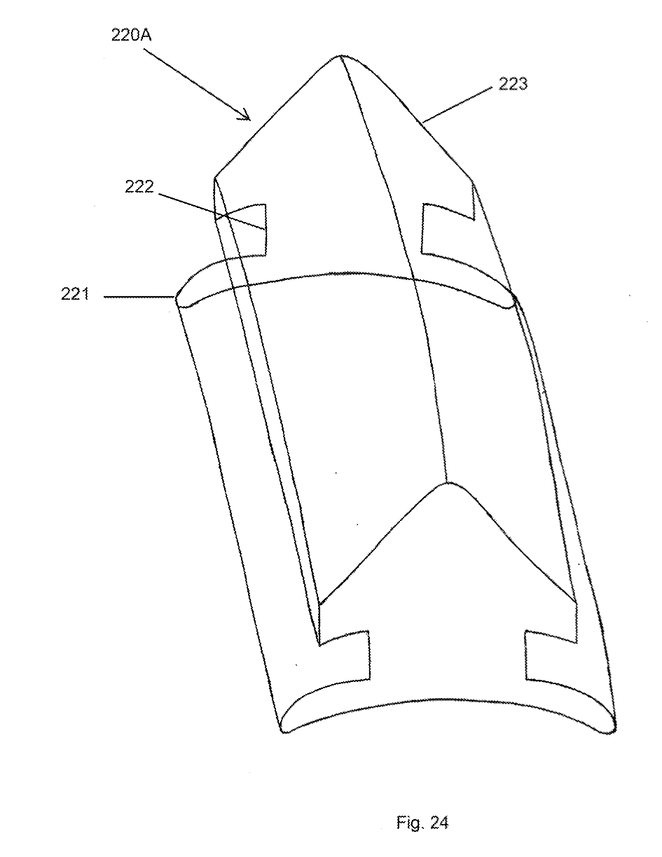

FIG. 24 shows an insertable attachment mechanism (217) having a base portion (221) that fits through the slot (118) and expands along the undersurface (119) of the tire. A notch (222) in the insert engages the tire body (116) along the edges of the slot (118). The outer portion (223) of the insert (220A) may be of any shape or tread design providing a riding surface (112) that engages the road. Once the insert (220A) is advanced through the tire body (116), inflation of the inner tube (105) locks the base (221) of the insert (220A) against the undersurface (119) of the tire body (116). This embodiment encompasses insertable attachment mechanisms in the form of a continuous base portion supporting multiple outer portions in series around the circumference of the tire. In other words, the base portion (221) may be a continuous circular strip with multiple outer portions projecting from the strip. Similarly, the outer portions (223) of the insertable mechanism (217) may be of sufficient dimensions such that the outer portions (223) meet to form a continuous riding surface.

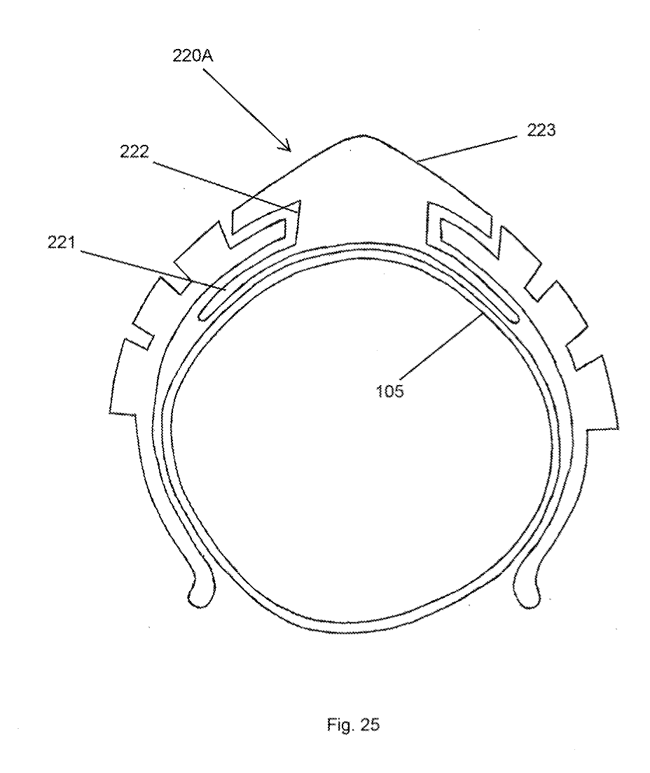

FIG. 25 is a cross sectional view of the insert (220) in place with the inner tube (105) fully inflated to lock the base (221) of the insert (220) in place. The notches (222) along the edge of the insert (220) engage the tire body (116) for additional security.

FIG. 26, as noted above, shows the slots (118) in the tire perpendicular to the long axis of the tire body (116). This embodiment improves stability of the tire body (116) upon inflation of the inner tube (105). As the inner tube (105) inflates, the tire body (116) expands in a circumferential manner, which tends to stretch the slot (118) in the same direction. A stretched slot (118) poses the risk that the inserts (220A) of FIG. 24 may become dislodged during a ride. Also, the stretching of the slot (118) raises the risk that the inner tube (105) will protrude through the slot (118) and be exposed to puncture. The slot (118) orientation of FIG. 26 diminishes these risks.

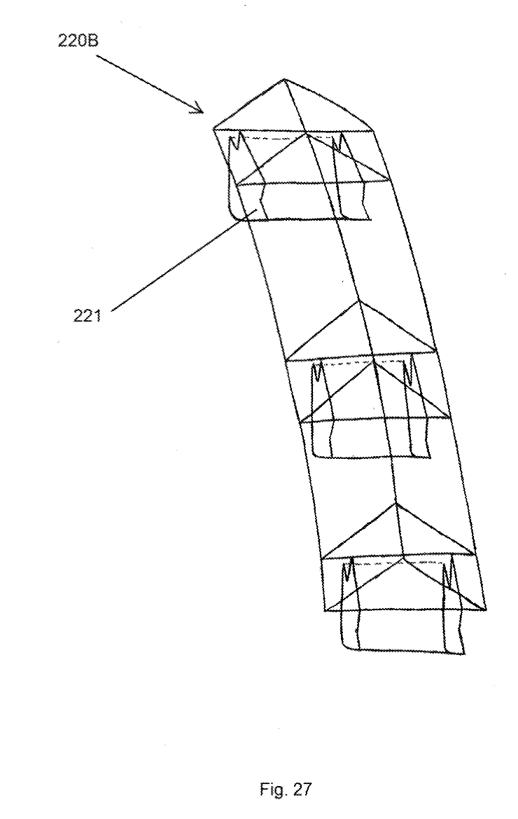

FIG. 27 shows yet another insert (220B) for providing an adjustable riding surface (112) that engages the road. The base (221) of the insert (220B) is oriented for fitting within the slots (118) shown in FIG. 26 (i.e., the slots (118) that are perpendicular to the long axis of the tire body (116)). The base (221) of each respective insert (220B) fits within a slot (118) and engages the undersurface (119) of the tire body (116).

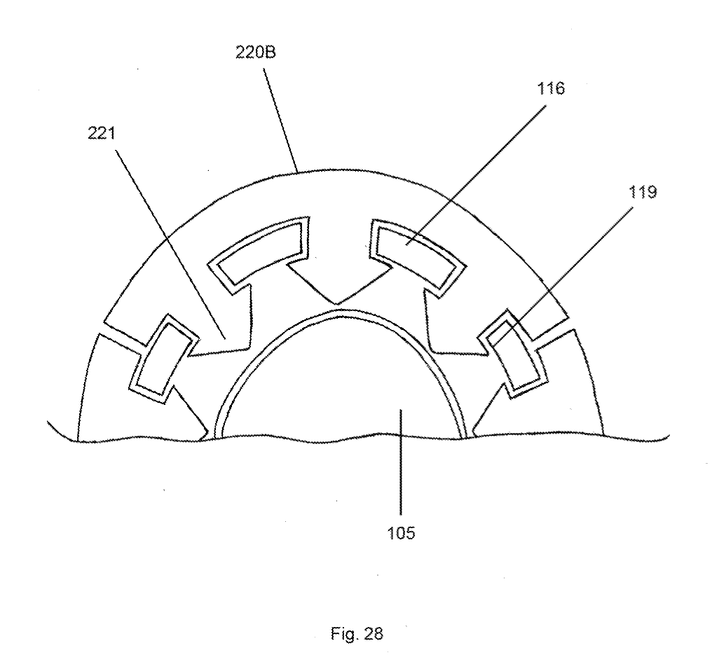

FIG. 28 is a cross sectional view of the long axis of the tire body (116) (i.e., a cross section taken along the center line of the tire circumference with the inner tube deflated).

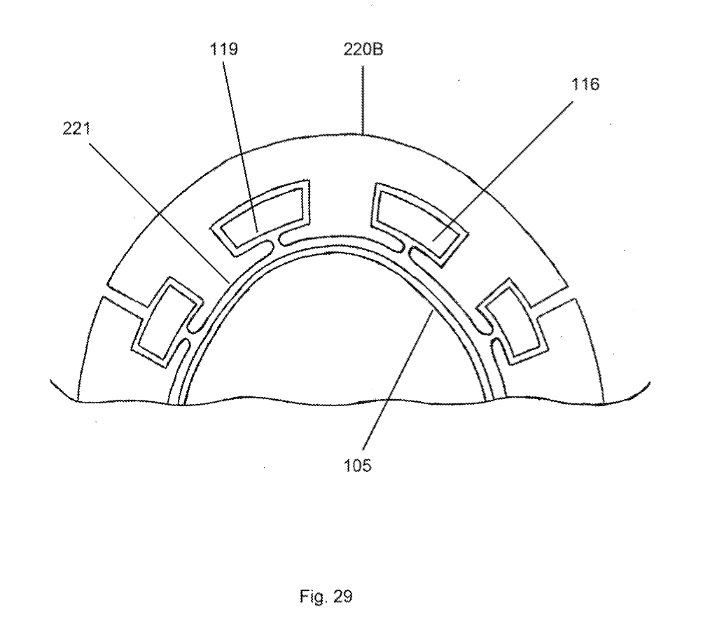

FIG. 29 illustrates that the base (221) of the insert (220B) shown in FIG. 28 may be formed of a pliable polymeric material that flattens in the presence of pressure from an inflated inner tube (105). By flattening against the undersurface (119) of the tire body (116), the pliable base (221) engages the tire body (116) along greater surface area for a more secure fit.

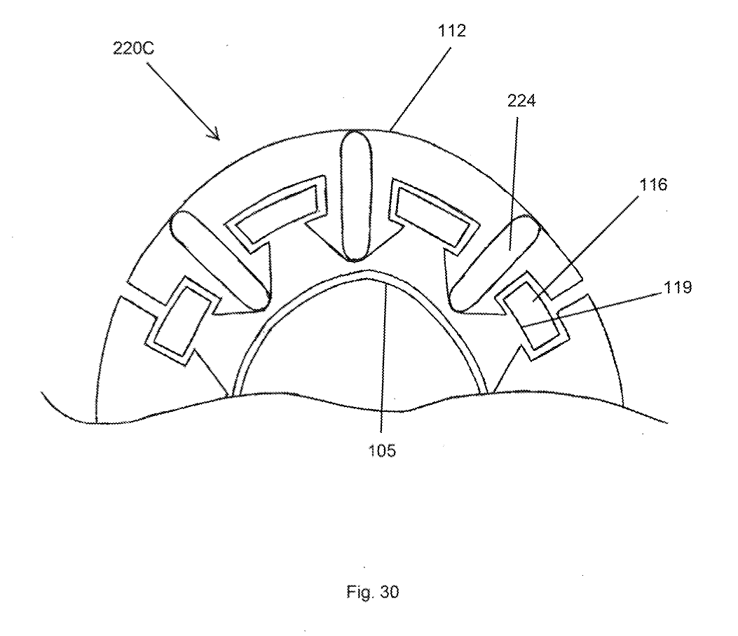

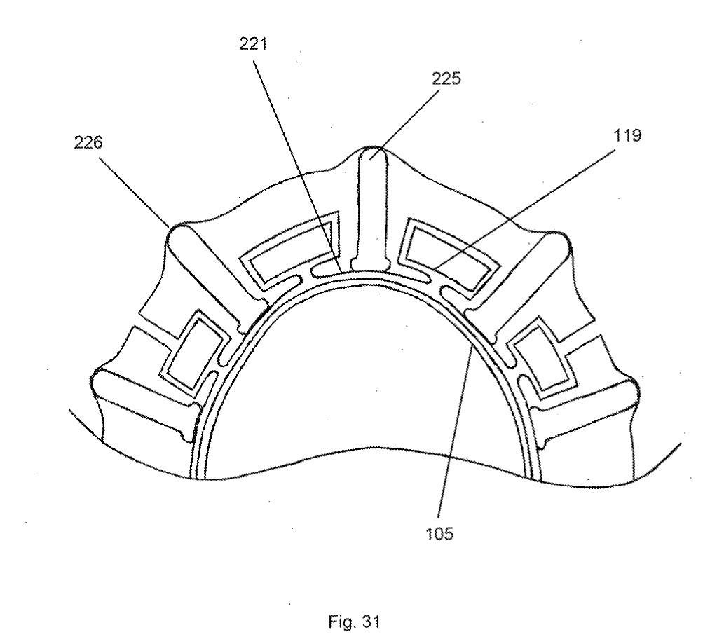

FIGS. 30 and 31 illustrate a new kind of insert (220C) for adjusting the riding surface (112) on a bicycle tire (101). In FIG. 30, the insert (220C) that engages a slot (118) in the tire body (116) includes an implanted pellet (224). The implanted pellet (224) is adapted to extend from the base of the insert to the riding surface (112) of the insert (220C). The implanted pellet (224) is secured in a radial configuration within the insert (220C). As shown in FIG. 31, upon inflation of the inner tube (105), the base (221) compresses and flattens against the undersurface (119) of the tire body (116). This compression pushes the pellet (224) outward, causing a deformation in the contour of the insert (220C). This deformation creates nodes (226) corresponding to each pellet tip (225) and adjusts the riding surface (112) accordingly. This embodiment allows the rider to control the surface area of the tire (116) that engages the road surface. In a preferred embodiment, the pellet (224) minimizes this surface area and reduces friction for faster travel. The rider controls the height to which the pellet (224) rises outwardly by controlling the extent to which the inner tube (105) is inflated. This gives the rider more options in adjusting the tire (116) for various road conditions.

### Implantables

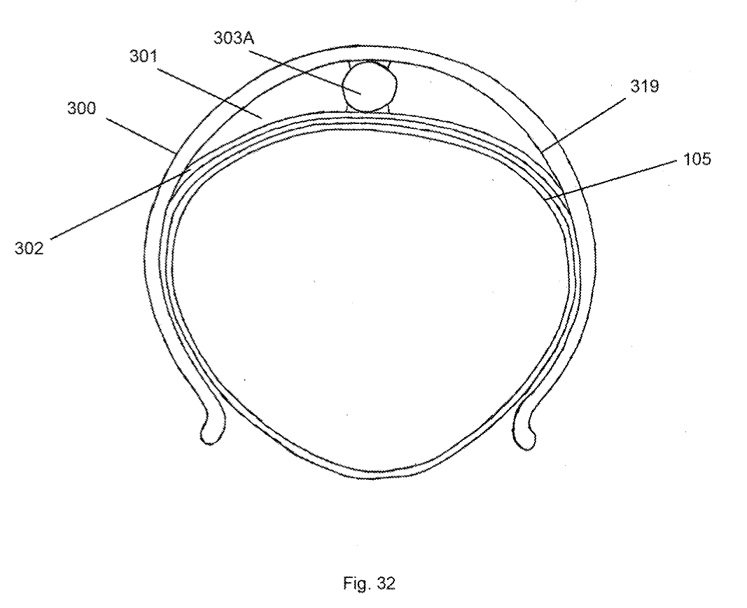

FIG. 32 illustrates a new tire (300) that defines a cavity (301) along the outer aspect of the tire (300) between the tire undersurface (319) and a separating membrane (302) that is positioned adjacent to the inner tube (105). The separating membrane (302) is attached to the undersurface (319) of the tire along opposite edges. FIG. 32 is a cross sectional view of the tire (300) having a cavity (301) therein for receiving a tubular shaped circumferential implant (303A). The tubular implant (303A) is secured to the undersurface (319) of the tire (300) and the separating membrane (302) such that the implant (303A) is in a fixed midline position along the circumference of the tire (300). The implant (303A) is adapted to press against the undersurface (319) of the tire body (300) to adjust the riding surface (112) that engages the road. Inflation of the inner tube (105) forces the tubular implant (303A) to be displaced outwardly, creating contour deformation of the tire body (300). The rigidity of the separating membrane (302) may be designed to ensure that inner tube (105) inflation causes corresponding deformation of the outer surface of the tire body (300) and not simply deformation of the inner tube (105). In this way, the rider adjusts the surface area of the tire (300) that engages the road for faster or slower travel, depending upon riding conditions.

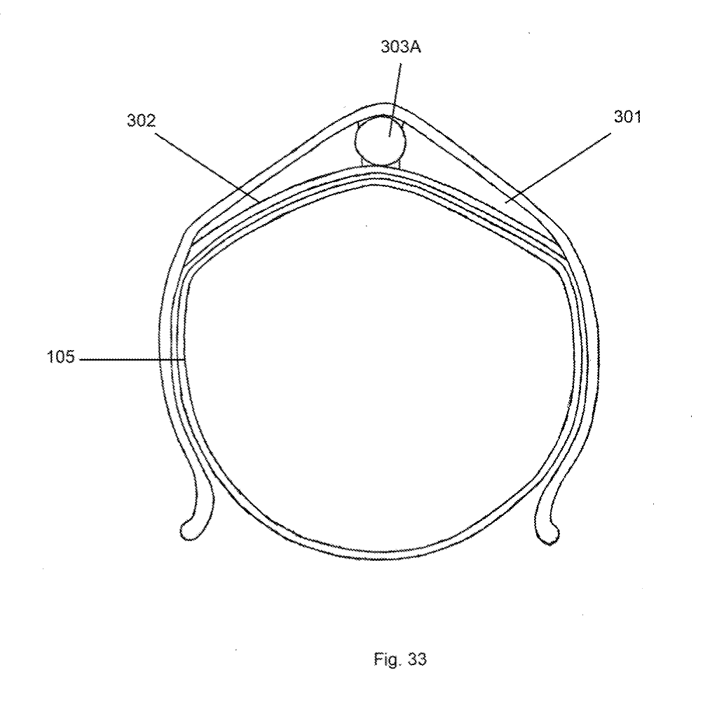

FIG. 33 is a cross sectional view of the embodiment of FIG. 32 with the inner tube (105) fully inflated. The tubular implant (303A) protrudes to a maximum extent and forms a sharper edge on which the tire body (300) contacts the road. In one aspect, the tubular implant (303A) of FIGS. 32 and 33 is non-compressible for maximum deformation of the tire body (300). The cavity (301) formed by the separating membrane (302) may be filled with polymeric materials or air, depending upon the need for shock absorption. A filled cavity (301) may be used to stabilize the position of the tubular implant (303A).

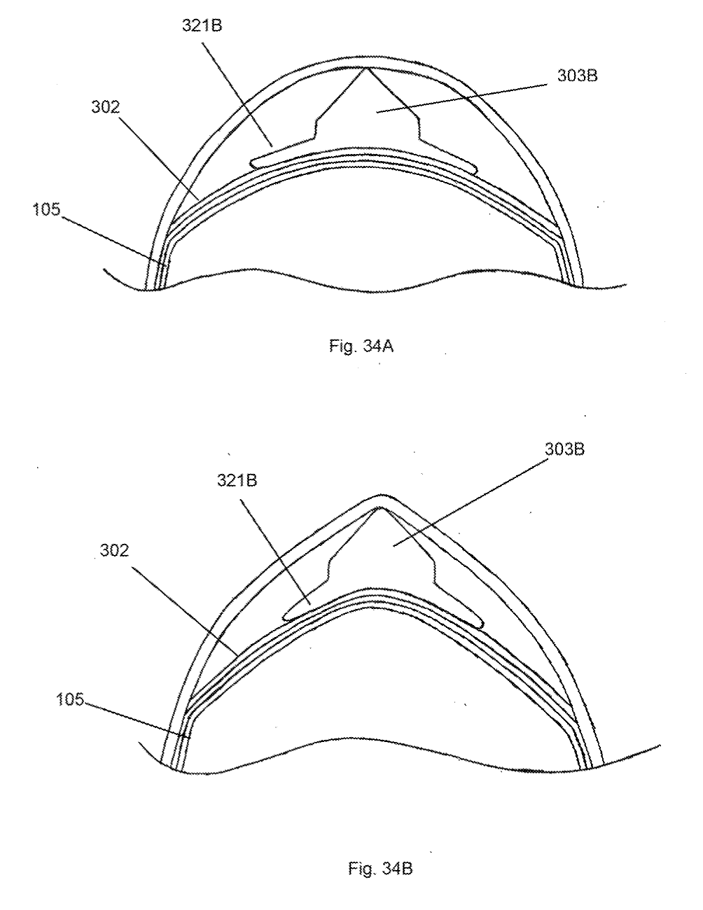

FIGS. 34A and 34B show another configuration for the implant (303B) used in the cavity (301) explained above. In this embodiment, the implant (303A) may be any polygonal shape that provides the desired riding contour on the outer surface (112) of the tire body. As shown in these figures, the implant (303B) has a relatively triangular shape with a flattened base (321B) adjacent to the separating membrane (302). The apex of the triangle protrudes outwardly and defines the riding surface (112) that engages the road. The apex may be of any desirable contour for optimal traction with the road, depending on riding conditions.

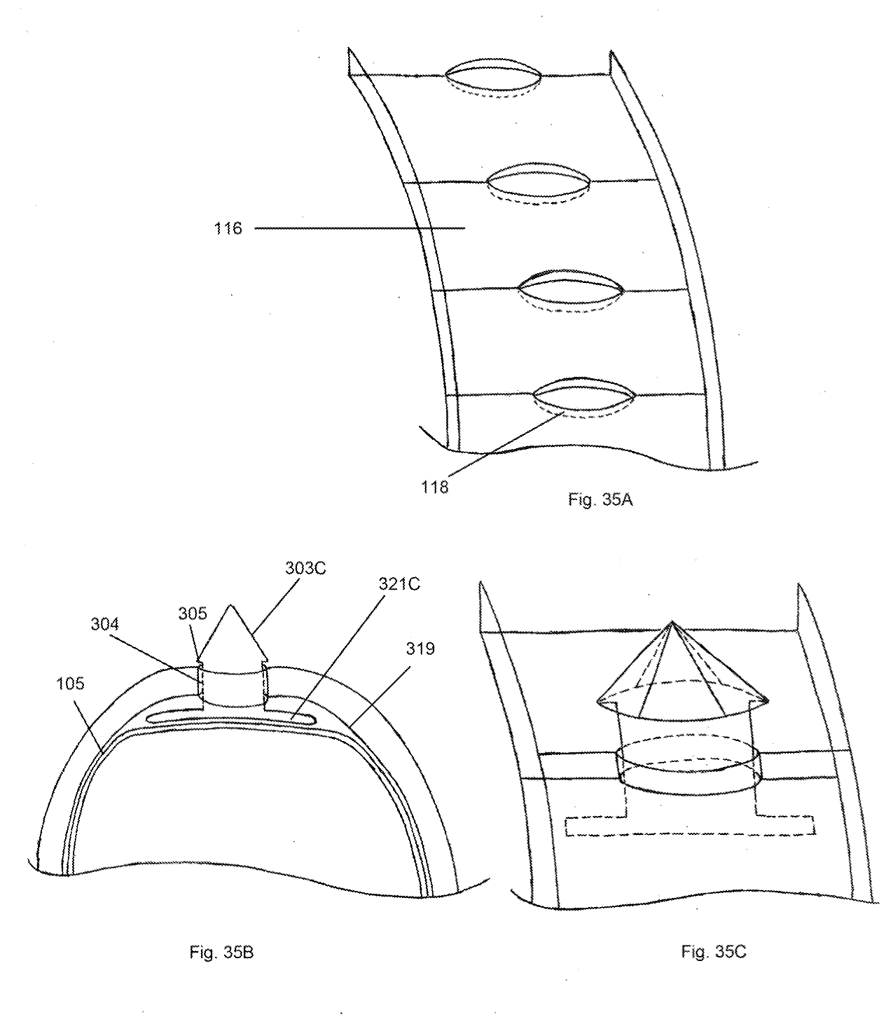

FIGS. 35A, 35B, and 35C illustrate perspective views and cross sectional views of a slotted tire (116) adapted to receive an implant (303C) having a circular base (321C) and an outer riding surface (112) with a cone configuration. The opening (118) in the tire (116) is constructed for the implant (303C) to be inserted through the undersurface (319) of the tire body (116) with the base (321C) fitting between the inner tube (105) and that undersurface (319). The implant is formed with a neck (304) extending between a base (321C) and a cone-shaped riding surface (112). Generally, the cone shaped riding surface (112) is of a greater circumference than the neck (304) and provides a lip (305) for engaging the outer surface of the tire body (116). By deflating the inner tube (105), positioning the implants (321C) through the slots (118) in the tire body (116), and re-inflating the inner tube (105), the implant (321C) of this invention is secured to the undersurface (319) of the tire (116). Upon re-inflating the inner tube (105), the base (321C) of the insert (303C) engages the undersurface (319) of the tire body (116) and the inner tube (105) for a secure fit. This embodiment is conducive to a rider owning variously shaped implants (303C) and choosing specific implants (303C) depending upon road conditions. The cone shaped riding surface (112) is one example but does not limit the invention, as other shapes may be used as necessary. The base (321C) may be a continuous strip supporting multiple cone shaped riding surfaces (112) in series for fitting around the circumference of the tire.

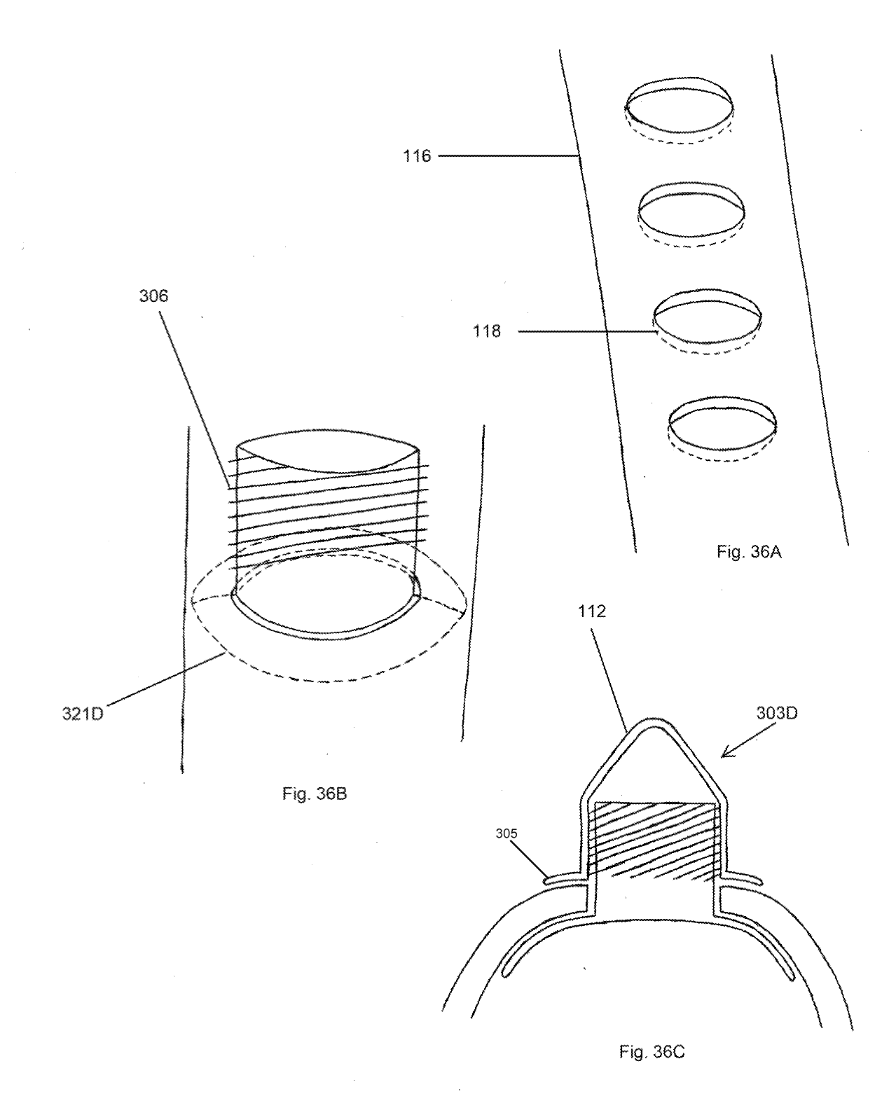

FIGS. 36A, 36B, and 36C are perspective and cross sectional views of a slotted tire (116) adapted to receive an implant (303D) having a circular base (321C) and an outer riding surface (112) with variable configurations. The implant (321D) of this embodiment fits within the tire (116) in the same manner as those of FIG. 35. In this embodiment, however, the outer riding surface (112) screws on to a threaded neck portion (306) of the implant (303D). The threaded neck (306) extends through the tire body (116) for easy access and allows the rider to attach variously shaped riding surfaces (112) onto the implant (303D). Additionally, the neck (306) of the implant (303D) defines a lip (305) about its circumference that engages the outer surface of the tire body (116).

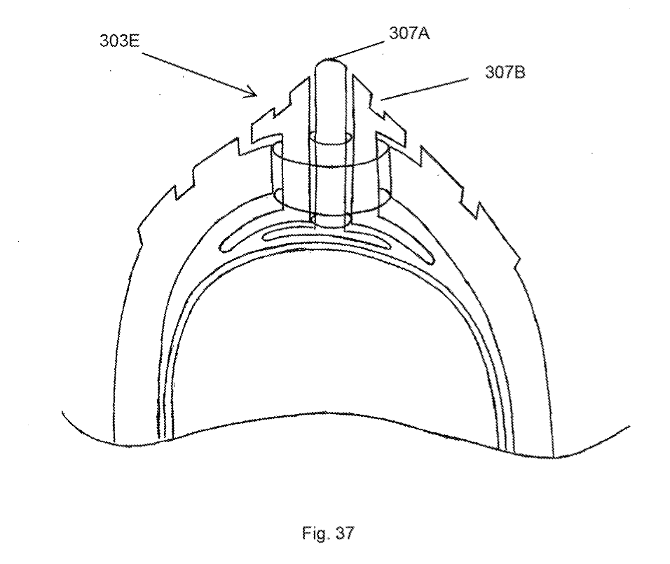

FIG. 37 adds another feature to the implant of FIG. 35 by separating the implant (303E) into two separate portions (307A, B) for greater control over the design of the riding surface (112). The portions include a smaller inner implant (307A) within an outer implant (307B) that encircles the inner portion (307A). The inner (307A) and outer (307B) portions of the implant (307A, B) are separately configurable for maximum design choices depending on road conditions.

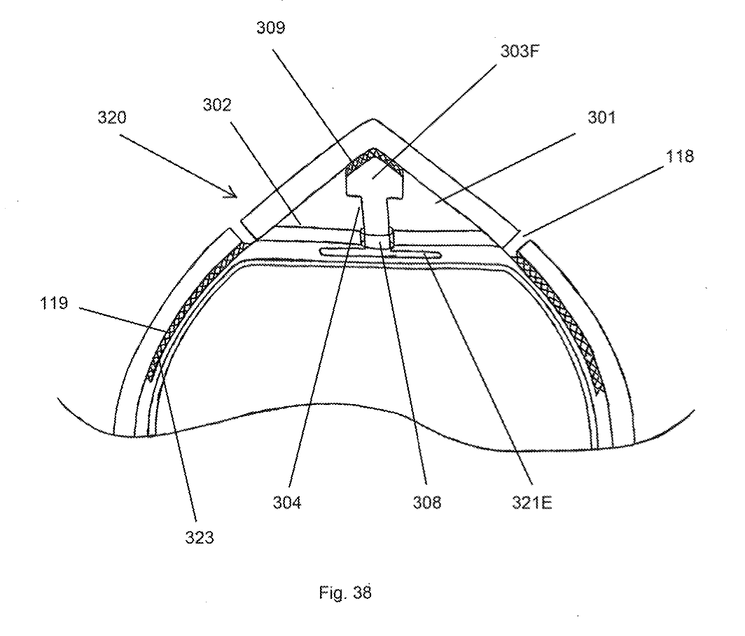

FIG. 38 shows a cross sectional view of a hybrid structure that includes an insert (320) with an implant (303A). The overall insert (320) has winged tabs (323) that fit within a slot (118) in the tire (116) and connect to the undersurface (119) of the tire by attachment mechanisms (117) such as hook and loop designs. In this way the insert (320) may be positioned within the tire (116) without removing the tire from the rim (106). In addition, the insert (320) defines a cavity (301) within its body containing an implant (303F) that is held in place by a membrane (302) having a collar (308) through which the neck (304) of the implant (303F) extends. The implant (303F) includes a base (321E), a neck (304), and a head (309) similar to the previously described implants (303). The base (321E) is positioned adjacent the inner tube (105) such that inflation of the inner tube (105) controls the maximum extent to which the implant (303F) protrudes outwardly through the collar (308) in the insert (320). This protrusion deforms the outer portion of the insert (320) which is the riding surface (112) that engages the road.

### Inflatables

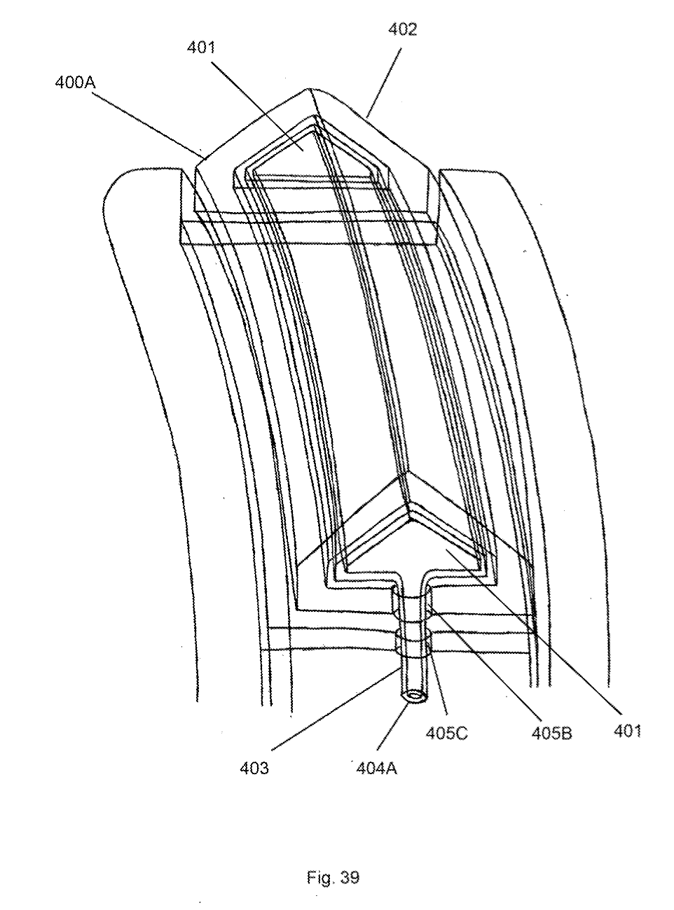

FIG. 39 shows the grooved tire (116) fitted with an inflatable strip (400A) for altering the shape of the riding surface (112) that engages the road. The inflatable strip (400A) shown in FIG. 39 includes varying tread surfaces (414) in accordance with earlier described embodiments. In other words, the inflatable strip (400A) may include all of the tread surface styles (414) from any other embodiment discussed herein. Within the inflatable strip (400A) there is a bladder (401) which extends continuously and circumferentially around the groove (113) of the tire (116). The bladder (401) may be inflated to varying pressures depending on the road conditions that the rider encounters. The bladder (401) has an expandable nature that accommodates numerous shapes, including the substantially triangular-shaped strip (400A) shown in FIG. 39. This triangular-shaped strip (400A) creates a thin riding surface (112) at the apex (402) of the triangle. The more pointed the apex (402), the less surface area and friction that the tire (116) encounters on the road. In this regard, the rider inflates the bladder (401) to determine the sharpness of the apex (402). The bladder (401) may be entirely enclosed within the body of the strip (400A) or the back of the bladder (401) may form the back wall of the strip (400A) for engaging the grooved tire (116). The bladder (401) includes its own air conduit (403) for inflation, which extends from the interior of the bladder (401) through the grooved tire (116) surface, through the inner tube (105), and through the rim (106) of the tire to provide an access port (404A) for adding air to the desired bladder pressure (401). Accordingly, in the embodiment of FIG. 39, the groove (113) of the tire, the inner tube (105), and the rim (106) all include respective holes (405A, E) for receiving the bladder air conduit (403). Although it is not shown in the drawing of FIG. 39, the attachment of the strip (400A) to the groove (113) in the tire (116) may be reinforced by hook and loop layers or any other attachment mechanisms (117). It is also noted that the back wall of the strip (400A) must fit flatly against the groove (113) in the tire (116). The invention avoids situations in which the bladder (401) inflates such that the strip (400A) bows away from the groove (113). In other words, the back wall of the strip (400A) must be sufficiently strong to remain flat even when the bladder (401) is inflated to the maximum pressure. This avoids any tendency for the back wall of the strip (400A) to bulge and not fit securely into the groove (113), compromising the stability of the strip (400A).

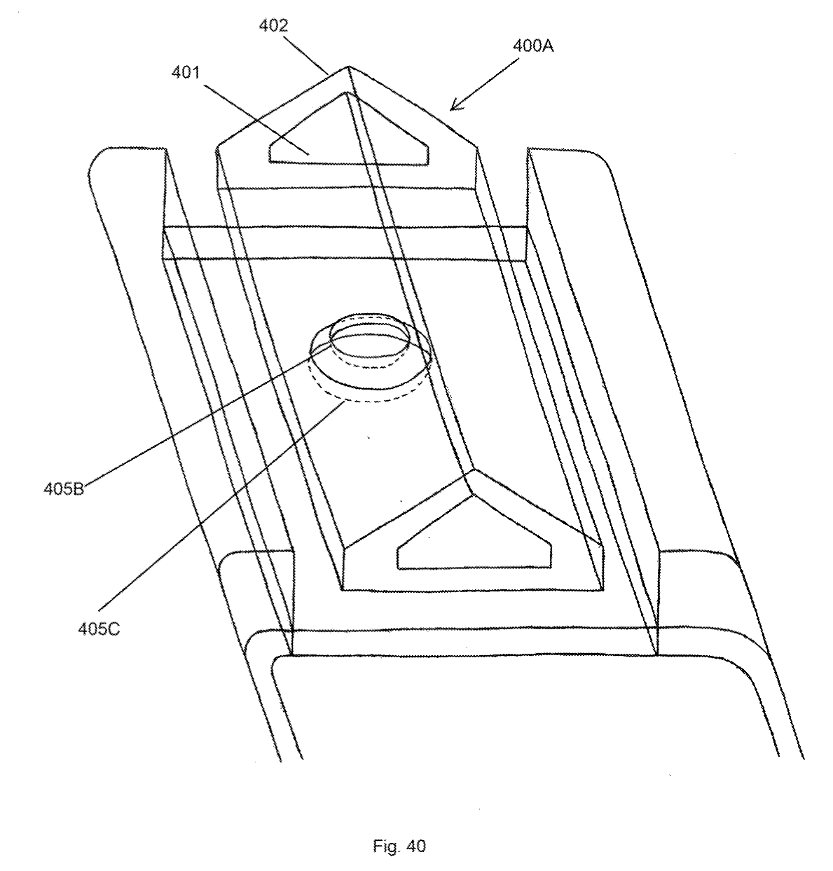

FIG. 40 is a perspective view of an inflatable strip (400A) as shown in FIG. 39 but illustrates a close up view of the hole (405B) in the back wall of the inflatable strip (400A) (smaller circumference) and the hole (405C) through the groove (113) in the tire (116) (larger circumference).

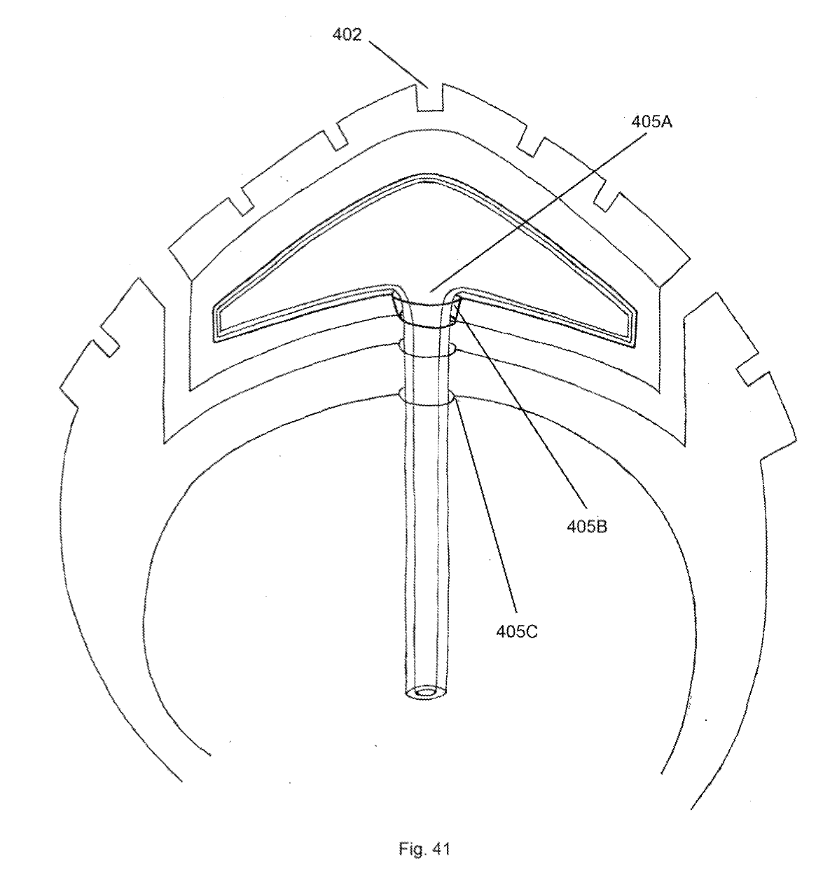

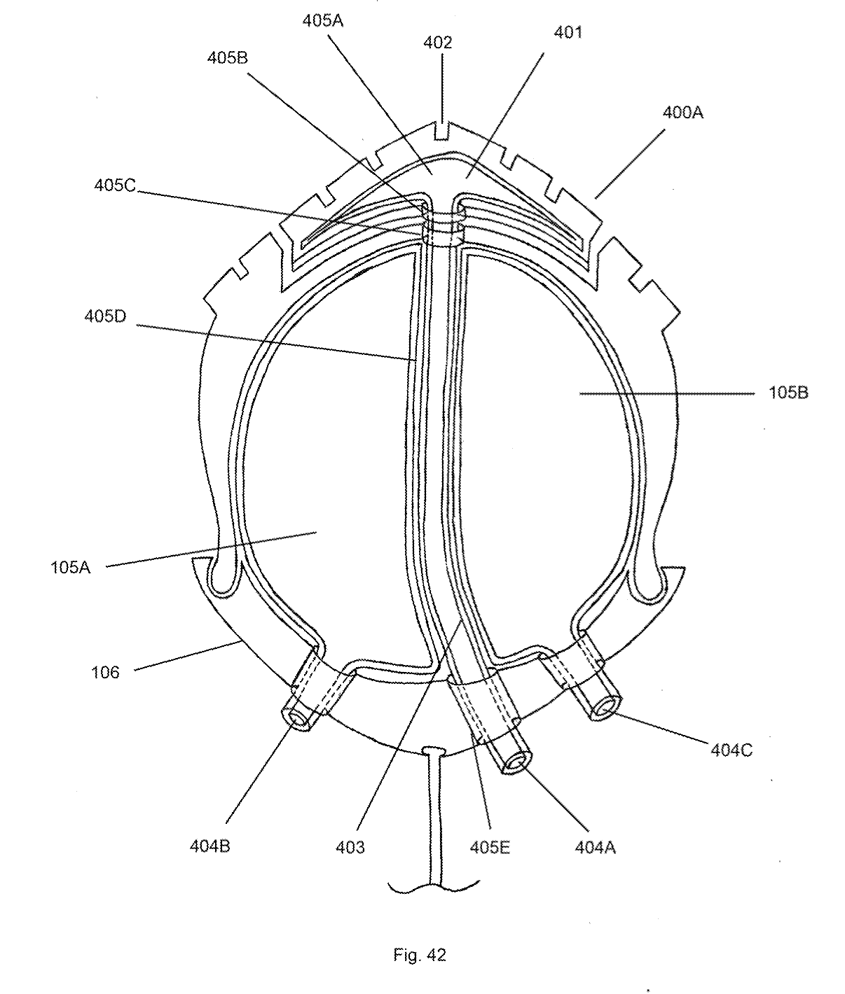

FIGS. 41 and 42 shows the same functionality as FIGS. 39 and 40 only with particular emphases on the bicycle tire structure, including the rim (106) and inner tube (105) within the overall grooved tire (116) apparatus. Accordingly, this view magnifies the holes (405A-E) necessary for the air conduit (403) of the inflatable insert (401) to pass through the back wall of the inflatable strip (405A), the groove (113) of the grooved tire (116), and the inner tube (105).

FIG. 42 shows a different embodiment that does not require such holes (405A-E) in the inner tube (105) because the single inner tube (105) of FIG. 41 is replaced with multiple inner tubes (105A, B). FIG. 42, therefore, shows two inner tubes (105A, B) inflated around the air conduit (403) that connects to the inflatable bladder (401) within the strip (400). The two inner tubes (105A, B) are positioned to run circumferentially parallel within the grooved tire (116). The air conduit (403) fits between the inner tubes (105A, B) and extends through the rim (106) to an access port (404). Each inner tube (105) may have a respective access port (404B, C) connected through the rim (106). To accommodate the inner tube access ports (404B, C) and the bladder access port (404A), the rim may include a total of three holes. In a different embodiment, the inner tube access ports (404B, C) may extend through a single hole in the rim (106). In the embodiment of FIG. 42, the bladder air conduit must be of sufficient strength to withstand compressive forces from the inflation of the inner tubes (105A, B).

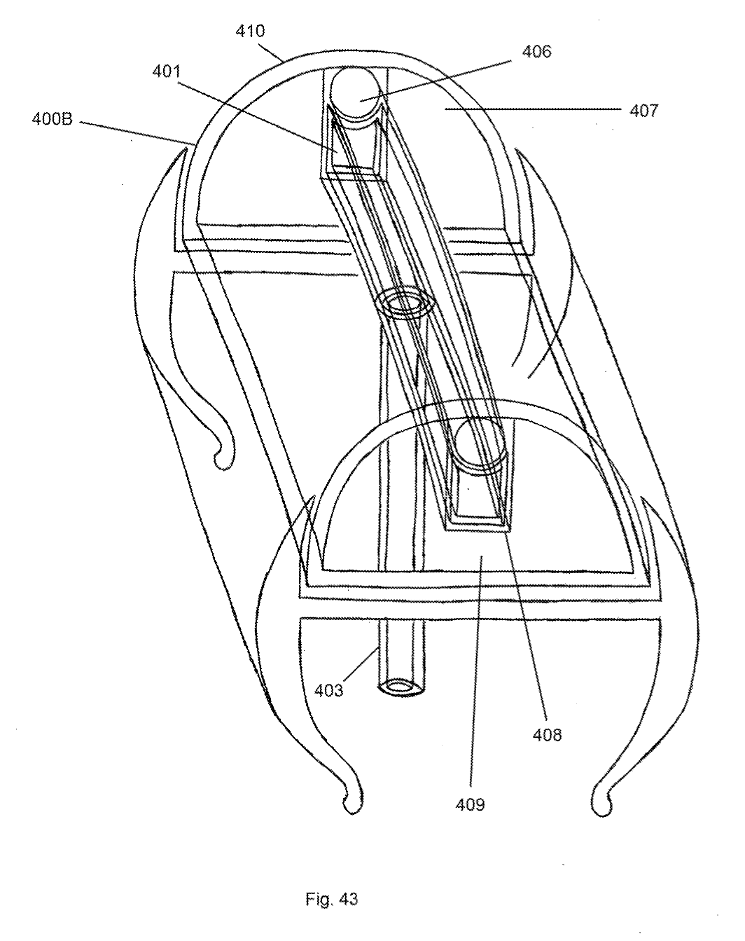

FIG. 43 shows an inflatable strip (400B) for placing within the groove (113) of a grooved tire (116). The strip (400B) includes a solid circumferential tube (406) for forming an adjustable riding surface (112) that engages the road. The strip (400B) includes solid sections (407) extending circumferentially within the groove (113) and forming the overall tread surface (112) for the tire. Between the adjacent solid sections (407), the strip (400B) defines a lumen (408) extending from the back wall (409) of the strip (400B) to the apex (410). In other embodiments, the solid sections (407) form a U-shape that surrounds the bladder (401). In other words, the solid sections (407) of the strip (400B) form a cavity in which the bladder (401) is positioned. The solid sections (407) must be sufficiently rigid to withstand air pressure within the lumen (408) without deformation. This thin, inflatable bladder (401) terminates directly adjacent the lower side of the circumferential tube (406). Inflating the bladder (401) via an air conduit (403) extending through an opening (405A) in the bladder (401) adjusts the height to which the tube (406) pushes against the riding surface (112) formed by the strip (400B). As shown in FIG. 42, the opening (405A) is defined by the junction of the air conduit (403) and the bladder (401). The air conduit (403) extends from this opening (405A) through the back wall of the strip (405B), through an opening (405C) in the groove (113) of the grooved tire (116), through an opening (405D) between the inner tubes (105A, 105B), and through an opening (405E) in the rim (106). For optimal control, the circumferential tube (406) may be connected to the bladder (401) by known means, or the tube (406) may be formed as an integral part of the bladder (401). In this way, the circumferential tube (406) provides an adjustable riding surface (112) for varying road conditions. To provide even more customization, the circumferential tube (406) may take any desirable form, such as a bullet shape that provides a sharper riding surface (112) that engages the road.

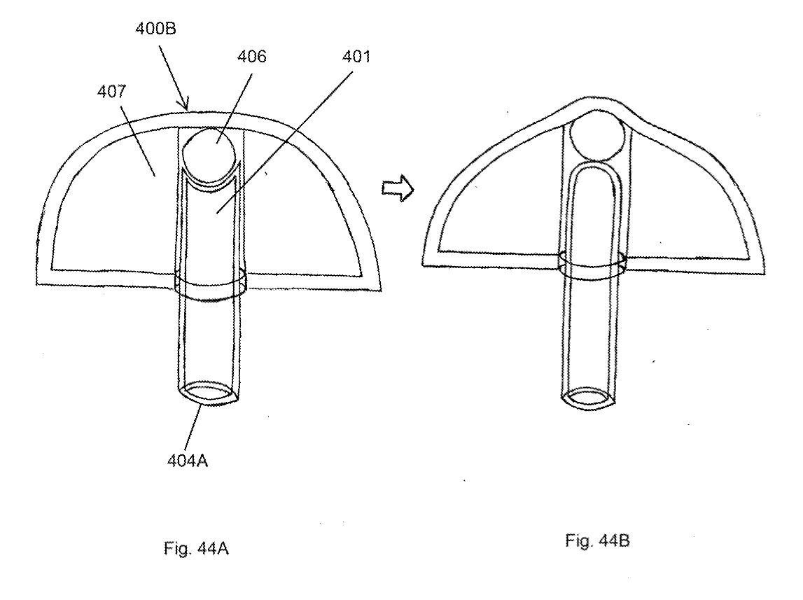

FIG. 44A shows the bladder (401) in its deflated state, allowing the circumferential tube (406) to rest entirely within the strip (400B). FIG. 44B shows the bladder (401) in its fully inflated state, pushing the circumferential tube (406) to its most distal position, deforming the riding surface (112) of the strip (400B).

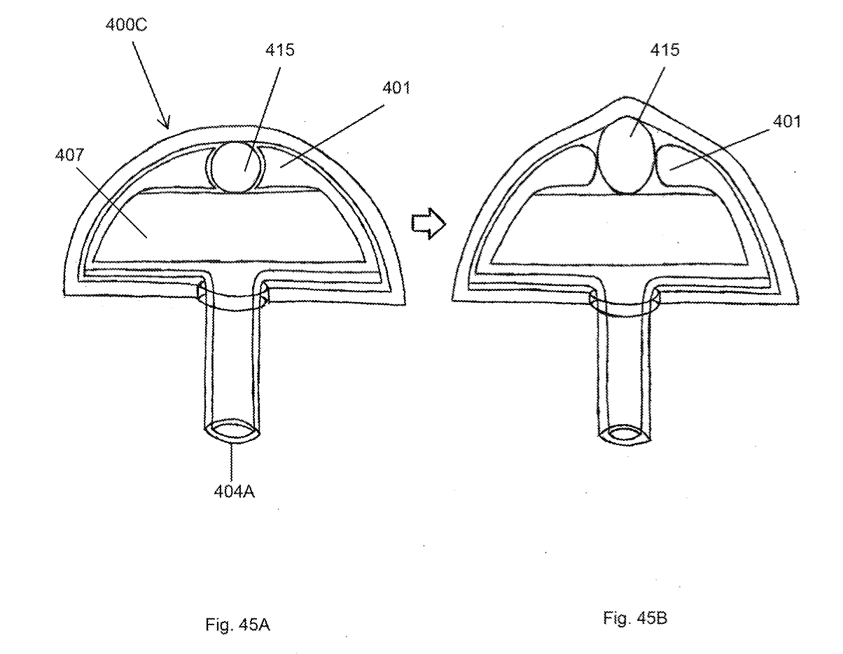

FIG. 45 shows an inflatable strip (400C) utilizing a deformable bead (415) to define the riding surface (112). In FIG. 45A, the strip (400C) includes solid central portion (407) surrounded by an inflatable bladder (401) extending around the solid central portion (407) and underneath the tread surface (112). As in prior embodiments, an access port (404A) is available from an opening (405E) in the rim (106) similar to the port (404) shown in prior figures. In FIG. 45B, as the rider increases the air pressure within the inflatable bladder (401), the air pressure exerts compressive forces on the deformable bead (415), causing the bead (415) to bulge outwardly. The bulging bead (415) defines the shape of the riding surface (112) on the strip (400C). The back side of the compressible bead (415) is directly adjacent the solid central portion (407), forcing all deformation from air pressure to extend outwardly beyond the tread surface (112), as shown in FIG. 45B.

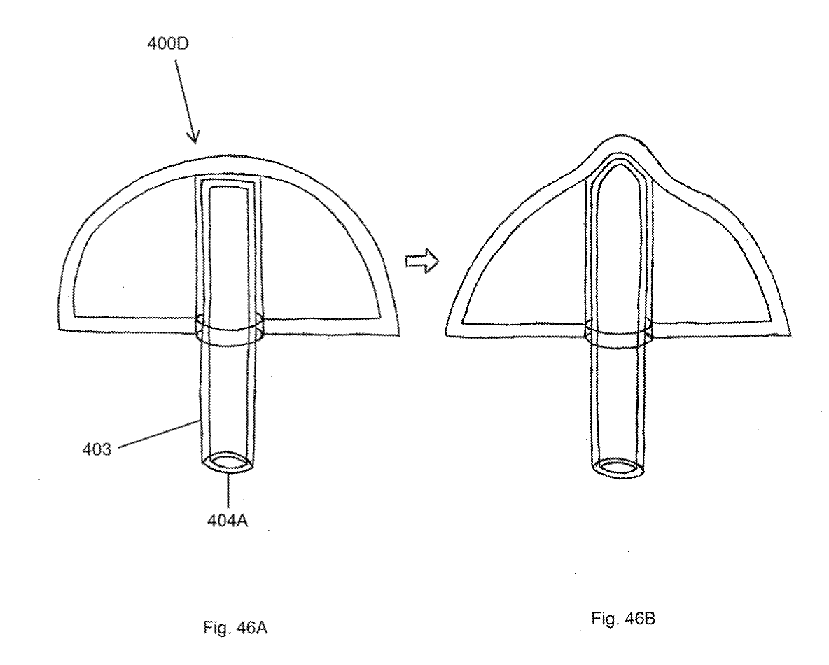

FIG. 46 shows a conduit (403) within a strip (400D) that fits within the groove (113) of a grooved tire (116). The conduit (403) is available to provide sufficient air pressure to deform the outer surface (112) of the strip (400D) and customize the riding surface (112) that engages the road. The conduit (403) would be accessible through the inner tube (105) and the rim (106) for easy access via an associated port (404A).

The strips of this invention are accessible for printing textual material on the strip for advertising or general display of logos. For example, the tread could advertise manufacturers of the tire, accessories for the vehicle, personalized logos, or trademarks and mascots for sports teams and such.

Embodiments of the modular tire and variable tread surfaces may be formed of any number of materials that are useful for riding on a road (i.e., rubber or other synthetics). The devices also may incorporate materials that are conducive to other riding experiences, such as magnetic or ferromagnetic materials that could be used in training apparatuses.

1. A tire having variable tread characteristics determined by removable riding surfaces, the tire comprising:
a tire body defining a slot extending circumferentially around the tire for receiving a removable riding surface.

2. A tire according to claim 1, wherein said removable riding surface extends about the circumference of the tire.

3. A tire according to claim 1, wherein the slot is positioned within a tread surface on the tire and approximately midway between the sidewalls of the tire.

4. A tire according to claim 1, wherein the slot is defined by a back wall and oppositely positioned vertical walls connected to said back wall, wherein said back wall and said vertical walls extend about the entire circumference of the tire.

5. A tire according to claim 1, wherein said removable riding surface comprises a removable strip.

6. A tire according to claim 5, wherein said removable strip attaches to the tire by side extensions for tucking into an associated rim of a wheel.

7. A tire according to claim 5, wherein said removable strip is connected to the slot by an attachment mechanism.

8. A tire according to claim 1, wherein said removable riding surface comprises interchangeable strips having diverse tread characteristics.

9. A tire according to claim 8, wherein said tread characteristics are selected from the group consisting of mountain type treads and road type treads.

10. A tire having a slot for receiving a removable riding surface, wherein the slot extends about the entire circumference of the tire, the tire comprising:
a back wall and oppositely positioned vertical walls connected to said back wall for defining the slot, wherein the back wall further defines openings for connecting the removable riding surface.

11. A tire according to claim 10, wherein the removable riding surface comprises an outer contour engaging the road and said outer contour has a shape selected from the group consisting of an angular riding surface, a rounded riding surface, a pointed riding surface, and an interrupted riding surface to reduce resistance between the tire and the road.

12. A tire according to claim 10, wherein the removable riding surface comprises a removable strip that fits into the slot and connects to the tire through the openings.

13. A tire according to claim 12, wherein said removable strip comprises at least one outer portion and at least one base portion connected to define a notch there between, wherein the notch engages sides of the opening.

14. A tire according claim 13, wherein said base portion is sufficiently flexible to fit through an opening and expand against an undersurface of the tire.

15. A tire according to claim 10, wherein said removable riding surface comprises a plurality of inserts that fit into respective openings in the slot.

16. A tire according to claim 15, wherein said inserts comprise an outer portion and a base portion connected to define a notch there between, wherein the notch engages sides of the opening.

17. A tire according to claim 16, wherein the outer portion defines a riding surface for reducing resistance between the tire and a road, said outer portion comprising a shape selected from the group consisting of an angular riding surface, a rounded riding surface, and a pointed riding surface.

18. A tire according to claim 16, wherein said base portion fits through an opening in said back wall of the slot.

19. A tire according claim 18, wherein said base portion is sufficiently flexible to fit through an opening and expand against an undersurface of the tire.

20. A method of attaching a removable riding surface to a tire, the method comprising:
positioning the removable riding surface such that inflating an inner tube secures the removable riding surface to the tire.
